(19) United States
(12) Patent Application Publication
(10) Pub. No.: US 2026/0103866 A1
(43) Pub. Date: Apr. 16, 2026

(54) APPARATUS AND METHOD FOR LIMITING SOUND TRANSMISSION

(71) Applicant: PULCEA LTD, Edinburgh (GB)

(72) Inventor: Ian JAMIESON, Edinburgh (GB)

(21) Appl. No.: 19/114,561

(22) PCT Filed: Sep. 27, 2023
(86) PCT No.: PCT/GB2023/052505

§ 371 Date: Mar. 24, 2025

(30) Foreign Application Priority Data
Sep. 28, 2022 (GB) 2214217.8

(51) Int. Cl. E02D 13/00

(52) U.S. Cl. CPC E02D 13/005

(57) ABSTRACT

In summary, there is provided apparatus (1) for limiting transmission of sound from a sound emitter (2), the apparatus comprising a container (4) arranged to at least partially surround a sound emitter, the container retaining a liquid, wherein the liquid comprises at least 2% dissolved oxygen, and wherein the apparatus further comprises an agitator (6) configured to agitate the liquid, to thereby cause the formation of gas bubbles (8) in the liquid.

### FIELD OF THE INVENTION

The invention relates to apparatuses for limiting sound transmission in liquids and associated methods.

### BACKGROUND TO THE INVENTION

Noise pollution, particularly as caused by heavy machinery, can be a serious problem affecting wildlife as well as the ability of humans to enjoy their environment. Many governments have imposed limitations on the amount of noise that can be generated in particular areas (including in underwater environments), both in terms of the absolute peak intensity of noise that can be generated, and in terms of noise that can be generated within a particular period (e.g. across a month or a year).

Nevertheless, there arises a need in some cases to operate machinery which creates such noise, and thus a need to limit the transmission of such noise. Present equipment for limiting the transmission of noise is large, expensive, requires large amounts of energy to run, and typically only works over relatively narrow frequency bands.

It is in this context that the present disclosure has been devised.

### SUMMARY OF THE INVENTION

A first aspect of the invention provides an apparatus configured to limit transmission of sound (e.g. through a liquid) from a sound emitter, the apparatus comprising a container arranged to at least partially surround a (e.g. the) sound emitter, the container retaining a liquid, wherein the liquid comprises at least 2% (optionally at least 10%) dissolved oxygen by volume, and wherein the apparatus further comprises an agitator configured to agitate (e.g. at least a portion of) the liquid (within the container), to thereby cause the formation of gas (e.g. oxygen) bubbles in the liquid (within the container).

The inventor has found that the formation of gas (e.g. oxygen) bubbles in the liquid limits the transmission of the sound through the liquid across a wide frequency band (e.g. including but not limited to frequencies that are audible to humans and including ultrasound frequencies). Agitation of liquid comprising at least 2% (e.g. at least 10%) oxygen has been found to be a particularly effective way to cause the formation of bubbles, as the agitation causes some of the oxygen dissolved in the liquid to be released from the liquid to thereby form a large quantity of gas (oxygen) bubbles as the liquid is agitated. Thus bubbles can be formed without the use of compressors or similar devices to force gas bubbles through the liquid, and the apparatus is therefore also more efficient than would be the case if a compressor were used for this purpose. Furthermore, a greater proportion (e.g. number) of bubbles are generated more quickly than would be the case were a compressor or traditional bubble curtain generator used to create bubbles. At least a portion of the bubbles may be formed by nucleation. At least a portion of the bubbles may be formed by cavitation.

Without wishing to be bound by theory, the inventor believes that sound transmission is limited by bubbles in the liquid because as the sound waves reach the bubbles they encounter repeated liquid-gas and gas-liquid interfaces (e.g. as the sound waves enter and exit each bubble). Some scattering and absorption can take place at each such interface, with the result that sound energy is absorbed and the sound is attenuated. The coefficients of reflection and absorption are believed to be a function of the acoustic impedance of the gas and liquid. There may also be some resonant absorption where the sound waves are of an appropriate frequency to cause resonance of some of the bubbles. As a large number of bubbles is produced and these bubbles have a large range of different sizes, a correspondingly large range of different wavelengths of sound may be scattered and absorbed by the bubbles. In other words, sound attenuation at a particular frequency is believed to be a function of bubble size. It is also believed that as the liquid contains a large proportion of gas in the form of bubbles, this results in a reduced speed of sound. Accordingly, the frequency spectrum of sound waves for which the sound transmission is limited (e.g. the frequency spectrum of sound waves which will be attenuated) is understood to be broad frequency spectrum, and dependent on bubble size, and on the distribution of bubble sizes.

The apparatus may be an apparatus configured to attenuate sound (e.g. through a liquid, e.g. liquid within the container). The apparatus may be an apparatus configured to restrict sound transmission (e.g. through a liquid, e.g. liquid within the container).

The liquid may comprise at least 2% (e.g. at least 10%) dissolved oxygen by volume. The liquid may comprise at least 25% dissolved oxygen by volume, e.g. at least 50%, e.g. at least 75%, e.g. at least 80%. The liquid may comprise less than 100% dissolved oxygen by volume, e.g. less than 99%, e.g. less than 90%. The liquid may have an oxygen saturation of at least 50%. The liquid may have an oxygen saturation of at least 80%. The liquid may have an oxygen saturation of at least 100%. The liquid may be supersaturated with oxygen, for example having an oxygen saturation above 100%. The liquid may have an oxygen saturation of at least 120%. The liquid may have an oxygen saturation of less than 200%, e.g. less than 150%. Saturated oxygen is more readily released from liquid to thereby form gas (oxygen) bubbles when the liquid is agitated, where higher dissolved oxygen percentages are present in the liquid.

In some examples, the liquid may comprise at least 5 grams of (dissolved) oxygen per kilogram of liquid, e.g. at least 10 grams of (dissolved) oxygen per kilogram of liquid, e.g. at least 20 grams of (dissolved) oxygen per kilogram of liquid, e.g. at least 50 grams of (dissolved) oxygen per kilogram of liquid, e.g. at least 100 grams of (dissolved) oxygen per kilogram of liquid (i.e. liquid in which the oxygen is dissolved, optionally water). The liquid may comprise less than 1,000 grams of (dissolved) oxygen per kilogram of liquid, e.g. less than 750 grams of (dissolved) oxygen per kilogram of liquid, e.g. less than 500 grams of (dissolved) oxygen per kilogram of liquid (i.e. liquid in which the oxygen is dissolved, optionally water).

The container may have at least one opening defined therein, such that the bubbles can leave the container via the opening. The container may have a plurality of openings defined therein. The at least one opening may be an opening in the top of the container, e.g. at or above the surface of the liquid. The container may have an open top side, e.g. at or above the surface of the liquid. It may be that, in use, gas (e.g. oxygen) bubbles are continuously generated, rise under buoyancy (in the case of very small bubbles this may occur after merging with other bubbles to thereby form larger bubbles), and leave via the opening(s).

The opening may define an area of at least 1 cm², e.g. at least 5 cm², e.g. at least 10 cm². The opening may define an area of less than 10 m², e.g. less than 7 m², e.g. less than 5 m². The opening may span the full upper surface of the container. The opening may define an area of at least 50% of the full upper surface of the container, e.g. at least 80%. Where a plurality of openings is provided, the total combined area of the openings may be at least 1 m², e.g. at least 2 m², e.g. at least 5 m². Where a plurality of openings is provided, the total combined area of the openings may be less than 50 m², e.g. less than 40 m², e.g. less than 30 m².

As gas (e.g. oxygen) bubbles tend to move buoyantly upwards (sometimes after merging with other bubbles), there is a need to continue to agitate the liquid to generate additional gas (e.g. oxygen) bubbles, such that there is a continuous stream of gas (e.g. oxygen) bubbles distributed throughout the container, e.g. across the height of the container. The provision of an opening allows the gas (e.g. oxygen) bubbles to leave the container and thus pressure within the container is not significantly increased. Accordingly, in use, gas (e.g. oxygen) bubbles will continuously be generated, will leave via the opening(s) and will be replaced with new gas (e.g. oxygen) bubbles as the agitation of the liquid continues.

The agitator may comprise (e.g. be) a stirrer. The agitator may comprise (e.g. be) a mixer. The agitator may comprise (e.g. be) an agitation pump, optionally an agitation pump in fluid communication with the interior of the container, e.g. via a conduit. The agitator may comprise (e.g. be) a flexible sheet (e.g. more flexible than the walls of the container). The agitator may comprise (e.g. be) a tarpaulin, for example a tarpaulin that is at least partially submerged in the liquid and which moves under action of waves in the liquid. The agitator may comprise (e.g. be) an actuator. The agitator may comprise (e.g. be) a transducer, e.g. a frequency generator (optionally an additional sound emitter, typically a sound emitter other than the sound emitter which emits the sounds which are to be limited in transmission by the apparatus). The agitator may comprise (e.g. be) a bubble curtain generator. The bubble curtain generator may be arranged (e.g. configured) to generate bubble curtain at least partially surrounding the sound emitter. The bubble curtain may be an annular bubble curtain. In other words, the bubble curtain may be in the form of a cylinder with an inner radius, an outer radius and a height, with the cylinder being defined by liquid (e.g. within the container) which contains bubbles (i.e. between the inner and outer radius and below the height), for example at least twice (e.g. at least 3 times, e.g. at least 5 times, optionally less than 100,000 times) as many bubbles may be present within the bubble curtain than are present outside the bubble curtain. The bubble curtain generator may comprise a compressor. The skilled person will appreciate that the pressure and volume output of the compressor may be selected in dependence on the volume of the container.

The use of a bubble curtain generator to agitate the liquid (e.g. within the container) allows for an even greater number of bubbles to be generated in the liquid (i.e. some arising as a result of the agitation causing dissolved oxygen to be released from the liquid and to thereby form bubbles, and some from the bubble curtain generator itself). A higher number of bubbles provides more effective sound attenuation and more effectively limits sound transmission.

The container may retain the sound emitter. The container may enclose the sound emitter. The container may contain the sound emitter. The sound emitter may be submerged in the liquid (e.g. within the container). Where the sound emitter is retained within the container and/or submerged in the liquid, the limitation of sound transmission is more effective.

The container may be a first container comprising one or more first container walls. The apparatus may comprise a second container, the second container comprising one or more second container walls. The second container may at least partially surround the sound emitter. The first container may at least partially surround and be spaced apart from the second container. In other words, the first container may retain the sound emitter and the sound emitter may be retained within the second container, such that the first container may also be considered to retain the sound emitter.

The or each of the one or more first container walls may be (e.g. substantially) rigid and/or may comprise one or more (e.g. substantially) rigid portions. The or each of the one or more second container walls may be (e.g. substantially) rigid and/or may comprise one or more (e.g. substantially) rigid portions. For example, the or each of the one or more first container walls and/or the or each of the one or more second container walls may comprise (e.g. be formed of) a (e.g. substantially) rigid plastics material, or may comprise a portion comprising (e.g. formed of) a (e.g. substantially) rigid plastics material. The or each of the one or more first container walls and/or the or each of the one or more second container walls may comprise (e.g. be formed of) a (e.g. substantially) rigid metal, or may comprise a portion comprising (e.g. formed of) a (e.g. substantially) rigid metal. The or each of the one or more first container walls and/or the or each of the one or more second container walls may comprise (e.g. be formed of) a (e.g. substantially) rigid glass or ceramics material, optionally a fibreglass material, or may comprise a portion comprising (e.g. formed of) a (e.g. substantially) rigid glass or ceramics material, optionally a fibreglass material. In an example, the one or more first container walls and/or the one or more second container walls may comprise (e.g. be formed of) a pipe comprising a (e.g. substantially) rigid plastics material.

The or each of the one or more first container walls may be flexible (e.g. resiliently deformable) and/or may comprise one or more flexible (e.g. resiliently deformable) portions. The or each of the one or more second container walls may be flexible (e.g. resiliently deformable) and/or may comprise one or more flexible (e.g. resiliently deformable) portions. The or each of the one or more first container walls may comprise tarpaulin. The or each of the one or more second container walls may comprise tarpaulin. The or each of the one or more first container walls may be water resistant, e.g. waterproof. The or each of the one or more second container walls may be water resistant, e.g. waterproof.

The or each of the one or more first container walls and/or the or each of the one or more second container walls may comprise (e.g. be formed of) a water-resistant material. The or each of the one or more first container walls and/or the or each of the one or more second container walls may comprise (e.g. be formed of) a UV resistant material. The or each of the one or more first container walls and/or the or each of the one or more second container walls may comprise (e.g. be formed of) a hydrogen peroxide resistant material. The or each of the one or more first container walls and/or the or each of the one or more second container walls may comprise a coating. The coating may be a salt water resistant coating. The coating may be a UV resistant coating. The coating may be a hydrogen peroxide resistant coating. The coating may be an anti-fouling coating. The or each of the one or more first container walls and/or the or each of the one or more second container walls may comprise (e.g. be formed of) a material that is sufficiently strong to withstand tidal forces. The or each of the one or more first container walls and/or the or each of the one or more second container walls may comprise reinforcing structures.

The one or more first container walls may comprise one or more first container side walls, extending from a base of the first container to a top of the first container. The one or more second container walls may comprise one or more second container side walls, extending from a base of the second container to a top of the second container. One or more first container side walls may extend above the surface of the liquid (i.e. the liquid within the first container, optionally a liquid outside the first container). One or more second container side walls may extend above the surface of the liquid (i.e. the liquid within the first container, optionally a liquid outside the first container). In an embodiment, the first container may comprise one or more first container side walls and may be open at the top and at the base. The container may comprise weights to weigh down the one or more first container walls, optionally so that they meet the ground or a floor (e.g. the sea floor). The container walls may be configured to meet the ground or a floor (e.g. the sea floor) in a watertight manner. There may be a seal between the container walls and the ground or a floor (e.g. the sea floor).

The second container may be within and spaced apart from the first container. Accordingly, a space may be defined between the first container and the second container (e.g. between the first container walls and the second container walls). The liquid (optionally a portion of the liquid) may be retained within the first container in the space between the first container and the second container (e.g. between the first container walls and the second container walls). The liquid (optionally a portion of the liquid) may be retained between the first container walls and the second container walls. The agitator may be retained in the space between the first container and the second container (e.g. between the first container walls and the second container walls). Advantageously, this provides for an option wherein the second container retains the sound emitter but need not retain any liquid. This is especially helpful where the sound emitter is a device or machine which cannot be operated if it is submerged in a liquid. In which case, the agitator may be used to agitate the liquid in the space between the first container and the second container (e.g. between the first container walls and the second container walls) and the bubbles thereby generated will limit the transmission of the sound as it travels from the sound emitter and into the said space. The second container may retain (e.g. a portion of) the liquid.

The first and/or second container walls may be water impermeable, optionally gas (e.g. oxygen) impermeable. However, this is not required, and in some examples the first and/or second container walls may be selectively permeable, e.g. water permeable, and gas (e.g. oxygen) impermeable. One or more of the first container walls may comprise a water permeable portion. One or more of the second container walls may comprise a water permeable portion.

The liquid may comprise (e.g. be) water. The liquid may comprise (e.g. be) an aqueous solution). Water is abundant and inexpensive. Water is also particularly useful where the sound emitter is marine piling equipment, as in such an instance water will already surround the sound emitter in use. The liquid may comprise (e.g. be) sea water, optionally an aqueous solution comprising sea water. The liquid may comprise (e.g. be) freshwater, optionally an aqueous solution comprising fresh water. The liquid may comprise (e.g. be) saline, optionally an aqueous solution comprising saline. The liquid may comprise (e.g. be) pure water, or an aqueous solution comprising pure water (e.g. water having a resistivity of approximately 10 MΩ·cm at 25° C.).

The liquid may comprise (e.g. contain) hydrogen peroxide (i.e. H₂O₂). The liquid may comprise (e.g. be) an aqueous solution comprising hydrogen peroxide. Hydrogen peroxide readily decomposes to form water and oxygen, according to the following equation:

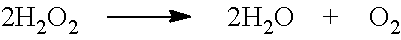

Hydrogen peroxide is thermodynamically unstable and can decompose spontaneously to form oxygen and water. Accordingly, a liquid comprising hydrogen peroxide (or an aqueous solution thereof) provides both a source of dissolved oxygen and in some cases a source of gas (e.g. oxygen) bubbles.

The liquid may comprise an aqueous solution comprising hydrogen peroxide at a concentration greater than or equal to 0.001 mg/L, or greater than or equal to 0.01 mg/L, or greater than or equal to 0.1 mg/L, or greater than or equal to 1 mg/L, or greater than or equal to 20 mg/L, or greater than or equal to 50 mg/L, or greater than or equal to 80 mg/L, or greater than or equal to 200 mg/L, or greater than or equal to 500 mg/L, or greater than or equal to 800 mg/L, or greater than or equal to 1,000 mg/L. The liquid may comprise an aqueous solution comprising hydrogen peroxide at a concentration less than or equal to 2,500 mg/L, or less than or equal to 2,200 mg/L, or less than or equal to 1,500 mg/L. The liquid may comprise an aqueous solution comprising hydrogen peroxide at a concentration from 20 mg/L to 2,500 mg/L, inclusive, or from 200 mg/L to 2,500 mg/L, inclusive, or from 20 mg/L to 2,200 mg/L, inclusive, or from 200 mg/L to 2,200 mg/L, inclusive. The liquid may comprise an aqueous solution comprising hydrogen peroxide at a concentration of approximately 1,500 mg/L (e.g. at a concentration of from 1,300 mg/L to 1,700 mg/L, inclusive). The aqueous solution may comprise hydrogen peroxide at a concentration of from 500 mg/L to 1,500 mg/L inclusive.

In an example, a 1,500 mg/L concentration of hydrogen peroxide could decompose to produce 0.609 Litres of oxygen per Litre, which is an excess of the quantities required to form sufficient bubbles to limit the transmission of sound.

Furthermore, if at least 10% of the volume of the container is made up of gas (e.g. oxygen) bubbles (e.g. as released from the dissolved oxygen in the liquid as a result of the agitation of the liquid) this could reduce the speed of sound in the liquid and bubbles to approximately 30 ms⁻¹. Given that

$$λ = \frac{v}{f}$$

where λ is the wavelength of a sound wave, v is the speed of sound in the medium, and f is the frequency of the sound, this is particularly helpful where the sound emitter is marine piling, as the peak frequency of sound emitted by marine piling is approximately 100 Hz, and thus has a wavelength of approximately 15 metres in normal sea water (where the speed of sound is approximately 1,500 ms⁻¹). However, where the speed of sound has been reduced to 30 ms⁻¹ due to the presence of bubbles, this wavelength falls to 0.3 meters. Accordingly, a 1-meter thick oxygen bubble curtain formed by bubbles as herein described will attenuate the sound emitted by marine piling equipment more effectively than traditional bubble curtains.

The absorption of sound (e.g. the limitation of sound transmission) by the liquid and bubbles is further believed to be connected to the total distance (e.g. path length) travelled by the sound waves through bubbles and the total distance (e.g. path length) travelled by the sound waves through liquid, in terms of multiple numbers of wavelengths of the said sound waves. Accordingly, reducing the size of the wavelengths of the sound waves for any frequency (e.g. by causing the sound waves to travel in a medium in which the speed of sound is reduced compared to the speed of sound in air or in water) results in enhanced absorption of sound at the said frequency. Hence, the limitation of sound transmission from the sound source is improved. As described above, it is believed that the speed of sound in a liquid containing a high density of bubbles is less than the speed of sound in air and less than the speed of sound in liquid. Accordingly, a liquid comprising a high density of bubbles is more effective at limiting sound transmission than an air gap, for example. Furthermore, bubbles created by oxygen being released from water containing a high proportion of dissolved oxygen will at least initially be very small (e.g. microscopic, e.g. on the order of a few microns in diameter or smaller) and thus particularly effective at limiting the transmission of higher frequencies.

The liquid may comprise (e.g. contain) an enzyme for the decomposition of hydrogen peroxide. The enzyme may be a peroxidase. The enzyme may be catalase, optionally synthetic catalase (e.g. as opposed to naturally occurring catalase). The aqueous solution may comprise (e.g. contain) an enzyme for the decomposition of hydrogen peroxide. The liquid (optionally the aqueous solution) may comprise an enzyme for catalytic decomposition of hydrogen peroxide at a concentration of 0.0001% w/w of water to 5% w/w of water, or 0.001% w/w of water to 5% w/w of water, or 0.05% w/w of water to 5% w/w of water, or at a concentration of 0.1% w/w of water to 4% w/w of water, or 0.5% w/w of water to 3% w/w of water. The aqueous solution may comprise an enzyme for catalytic decomposition of hydrogen peroxide at a concentration of at least 0.0001% w/w of water, or at least 0.001% w/w of water, or at least 0.01% w/w of water, or at least 0.03% w/w of water. The aqueous solution may comprise no more than 6% w/w of enzyme/water. The aqueous solution may comprise at least 0.001 mg/L, or 0.005 mg/L, or 0.05 mg/L, or 0.075 mg/L, or 0.75 mg/L, or 1 mg/L, or 1.5 mg/L of said enzyme per litre of water (e.g. per litre of sea water), and optionally not more than 20 mg/L, or 15 mg/L or 10 mg/L, or 1 mg/L, or 0.1 mg/L, or 0.01 mg/L. The weight ratio of the hydrogen peroxide to enzyme may be from 100:1 to 1:1, or from 50:1 to 1:1, or from 30:1 to 1:1, or from 10:1 to 2:1, or from 5:1 to 3:1. Ratios of hydrogen peroxide to enzyme as described herein provide adequate reaction of hydrogen peroxide (e.g. >95% of hydrogen peroxide reacted) to form bubbles. The aqueous solution may optionally comprise at least 10 mg/L, 50 mg/L, 200 mg/L, 300 mg/L, 400 mg/L, or 500 mg/L enzyme (e.g. catalase).

The liquid (optionally the aqueous solution) may comprise between 1 kU and 100 kU of enzyme (e.g. catalase) per 1 litre of water. The liquid (optionally the aqueous solution) may comprise at least 5 kU of enzyme (e.g. catalase) per 1 litre of water, or at least 10 kU, or at least 20 kU. The liquid (optionally the aqueous solution) may comprise no more than 150 kU of enzyme (e.g. catalase) per 1 litre of water, or no more than 170 kU, or no more than 200 kU, or no more than 500 kU. It will be understood that 1 U (1 enzyme unit) of enzyme (e.g. catalase) is the amount which decomposes 1 μmole of hydrogen peroxide per minute at pH 7.0 and 25° C. (e.g. while the hydrogen peroxide concentration falls from 10.3 mM to 9.2 mM), and that 1 kU is 1,000 times this amount. The skilled person may choose to use greater amounts of enzyme (e.g. catalase) such that this may be present in excess amounts.

Advantageously, the use of a liquid (or an aqueous solution) comprising hydrogen peroxide and an enzyme for catalytic decomposition of hydrogen peroxide means that more hydrogen peroxide is decomposed into oxygen and water (and/or this decomposition takes place at an accelerated rate) than is the case where a liquid (or an aqueous solution) comprises hydrogen peroxide and no (or very little of) such an enzyme. The amount of oxygen produced in total depends on the concentration of hydrogen peroxide (e.g. the quantity of hydrogen peroxide) used. The use of an enzyme means that lower concentrations of hydrogen peroxide may be used.

The apparatus may be configured (and/or the liquid, optionally the aqueous solution may be comprised) such that the concentration of hydrogen peroxide decreases by at least 5% in one hour, for example by at least 10% in one hour, optionally by at least 25% in one hour, typically by less than 80% in one hour, e.g. by less than 70% in one hour, e.g. by less than 60% in one hour (for example, where an initial concentration of 750 mg/L of hydrogen peroxide is provided). Advantageously, the decomposition of hydrogen peroxide at these rates leads to a steady supply of bubbles rather than too few bubbles in too long a period, or too many bubbles and then the need to re-supply hydrogen peroxide to create further bubbles. The apparatus may be configured to allow the re-supply of hydrogen peroxide at predetermined intervals (e.g. once every hour, or every 2 hours, or every 3 hours).

The liquid may comprise (e.g. contain) a surfactant. The liquid may comprise an aqueous solution comprising a surfactant. Advantageously, where a surfactant is provided, bubbles are less likely to leave the container at the liquid surface, and thus more gas can be retained (as the bubbles can be encouraged to flow back into the liquid, e.g. as the result of a flow of liquid caused by a pump). This means that it is not necessary to replace gas (e.g. oxygen) and/or gas (e.g. oxygen) bubbles in the liquid as frequently, and thus energy can be saved in causing the agitator to agitate the liquid. In some instances this also means that smaller quantities of chemicals (such as hydrogen peroxide and enzymes for the decomposition of hydrogen peroxide) are needed.

The surfactant may be a surfactant that has been rated as safe for use in a marine environment. The surfactant may be a surfactant that has been rated safe for use in a fresh water environment. The surfactant may comprise soap berries. The surfactant may comprise yucca extract. The surfactant may comprise a lecithin. The surfactant may comprise a monoglyceride. The surfactant may comprise a diglyceride. The surfactant may comprise a fatty acid. The surfactant may comprise a functionalised protein. The surfactant may comprise (e.g. be) a natural surfactant. The surfactant may comprise (e.g. be) a synthetic surfactant. The surfactant may comprise a tween surfactant. The surfactant may comprise sodium stearoyl lactylate. The surfactant may comprise calcium stearoyl lactylate. The surfactant may comprise sucrose esters.

An agitation region may surround the agitator. The agitator may be configured to cause sufficient bubbles to form that the combined volume of bubbles is at least 1% of the total volume of an (e.g. the) agitation region surrounding the agitator (e.g. wherein the agitator is located at the base of the agitation region), optionally after 60 seconds of operation of the agitator, e.g. after 2 minutes, e.g. after 5 minutes (optionally after less than 20 minutes, e.g. less than 18 minutes, e.g. less than 15 minutes). For example, it may be that sufficient bubbles are formed that the combined volume of bubbles is at least 2% (optionally 10%) of the total volume of the agitation region, e.g. at least 25% of the total volume of the agitation region. The agitator may be configured to cause sufficient bubbles to form such that the combined volume of bubbles is less than 99% of the total volume of the agitation region, e.g. less than 90%, e.g. less than 75%. The liquid and bubbles may together form a foam, for example a fluid foam. Higher proportions of bubbles (e.g. greater numbers of bubbles and/or a greater total volume of bubbles relative to the total volume of liquid) within the liquid may be more effective at limiting the transmission of sound from the sound emitter, through the liquid.

The apparatus (e.g. the agitator, optionally in combination with the fluid) may be configured to activate the agitator for an (e.g. initial) activation period, to thereby cause the generation of sufficient bubbles such that bubbles will then be suspended in the fluid for an attenuation period that is longer than the (e.g. initial) activation period. For example, the apparatus may be configured such that the agitator is activated for an initial activation period of at least 1 minute (e.g. at least 2 minutes, e.g. at least 5 minutes, optionally less than 60 minutes, e.g. less than 30 minutes, e.g. less than 15 minutes), leading to an attenuation period of at least 30 minutes, e.g. at least 2 hours, e.g. at least 4 hours, typically less than 12 hours, e.g. less than 8 hours, e.g. less than 6 hours. The skilled person will appreciate that an appropriate initial activation period and the following attenuation period will depend on various factors including the composition of the fluid, the temperature of the fluid, the size and configuration of the container, the peak acoustic pressure emitted by the sound emitter, etc. By selecting an activation period which will result in the generation of sufficient bubbles that the attenuation period is longer than the activation period (optionally taking into account the composition and/or temperature of the fluid and/or the size and configuration of the container and/or peak acoustic pressure emitted by the sound emitter, etc.), it is possible to provide a more efficient apparatus, because less energy is needed to continuously activate the agitator.

The agitator may be configured to cause bubbles to be generated, wherein the bubbles have an average (e.g. mean) diameter of at least 0.5 micrometres, e.g. at least 1 micrometre, e.g. at least 0.01 cm, e.g. at least 0.05 cm, e.g. at least 0.1 cm. The agitator may be configured to cause bubbles to be generated, wherein the bubbles have an average (e.g. mean) diameter of less than 1 cm, e.g. less than 0.5 cm, e.g. less than 0.2 cm. It may be that at least 50% of the bubbles generated have a diameter of between 1 micrometre and 0.1 cm, e.g. at least 75% of the bubbles generated may have a diameter of between 1 micrometre and 0.1 cm, e.g. at least 85% of the bubbles generated may have a diameter of between 1 micrometre and 0.1 cm. In an example, the agitator may be configured to cause bubbles to be generated, wherein the bubbles have an average (e.g. mean) diameter of 5 mm. The skilled person will appreciate that the diameters described hereinabove may refer to the maximum diameters of the bubbles from their generation to within 3 seconds of having been generated, optionally within 15 seconds of being generated, optionally within 1 minute of being generated (and that this may depend on the size of the container), and that bubbles may change in size over time (e.g. due to changes in pressure as they rise through the liquid, or due to merging with other bubbles).

The presence of hydrogen peroxide has been found to be particularly effective in causing the generation of smaller bubbles. Where the liquid comprises water, hydrogen peroxide, and an enzyme for the decomposition of hydrogen peroxide, and this liquid is agitated, it is possible to form sufficient bubbles to limit the transmission of sound in under 30 seconds. Accordingly, the apparatus (e.g. the mixer, e.g. with the liquid) may be configured to cause sufficient bubbles to form to limit the transmission of sound in under 30 seconds, e.g. under 20 seconds, e.g. under 10 seconds, e.g. under 5 seconds. The apparatus (e.g. the mixer, e.g. with the liquid) may be configured to cause sufficient bubbles to form to limit the transmission of sound (e.g. to reduce the sound pressure by at least 20 decibels) within 1 second, e.g. within 3 seconds. For example, the agitator may be configured to agitate a sufficient volume of liquid in a sufficiently short time period to cause sufficient bubbles to form to limit the transmission of sound (e.g. to reduce the sound pressure by at least 20 decibels) within 1 second, e.g. within 3 seconds. Where the liquid comprises hydrogen peroxide and an enzyme for the decomposition of hydrogen peroxide, it has also been found that the agitation of the liquid increases the rate at which the hydrogen peroxide decomposes into water and oxygen. Furthermore, such a liquid more effectively limits the transmission of sound than water comprising air bubbles, takes longer to dissipate when the agitation is stopped, and is re-formed faster when the agitation is resumed.

The agitator may be configured to cause at least 1,000 bubbles in a 1 Litre volume to be generated per minute that the agitator is operating, e.g. at least 10,000 bubbles in a 1 Litre volume, e.g. at least 100,000 bubbles in a 1 Litre volume. The agitator may be configured to cause less than 5,000,000 bubbles in a 1 Litre volume to be generated per minute that the agitator is operating, e.g. less than 1,000,000 bubbles in a 1 Litre volume, e.g. less than 500,000 bubbles in a 1 Litre volume. The skilled person will appreciate that the size and quantity of the bubbles generated will depend on several factors including, but not limited to, the temperature of the liquid, the pH of the liquid, the pressure within the liquid, the oxygen saturation of the liquid, the rate at which the agitator agitates the liquid (e.g. the rate of flow of liquid caused by the agitator), the presence or absence of any substances in the liquid, the types and concentrations of any substances in the liquid (e.g. hydrogen peroxide, enzymes, surfactants), etc.

The first container may define a volume of at least 0.5 m³, e.g. 1 m³, e.g. at least 5 m³, e.g. at least 10 m³, e.g. at least 15 m³ (optionally including the volume of the second container, where present). The first container may define a volume of less than 5,000 m³, e.g. less than 2,500 m³, e.g. less than 1,000 m³ (optionally including the volume of the second container, where present). The second container may define a volume of at least 0.25 m³, e.g. at least 0.5 m³, e.g. at least 4 m³, e.g. at least 8 m³, e.g. at least 10 m³. The second container may define a volume less than 2,000 m³, e.g. less than 1,000 m³, e.g. less than 500 m³. The space between the first container and the second container (e.g. between the first container walls and the second container walls) may define a volume of at least, 0.25 m³, e.g. at least 0.5 m³, e.g. at least 1 m³, e.g. at least 2 m³, e. at least 5 m³. The space between the first container and the second container (e.g. between the first container walls and the second container walls) may define a volume of less than 3,000 m³, e.g. less than 1,500 m³, e.g. less than 500 m³. The skilled person will appreciate that the scale of the apparatus and thus the container(s) may be selected in dependence on the scale of the sound emitter. Such volumes are suitable for (e.g. at least partially) surrounding large sound emitters such as heavy machinery, for example drilling equipment, marine piling equipment, etc.

The container may comprise one or more barriers, the or each barrier extending at least partially across an interior of the container to thereby form a plurality of sub-containers. Each of the plurality of sub-containers may have a respective agitator provided therein. Each of the plurality of sub-containers may have a respective aperture defined therein, each respective aperture being arranged to allow bubbles to leave the respective sub-container (and optionally the container). The one or more barriers may extend in a horizontal direction. The one or more barriers may extend in a vertical direction. The one or more barriers may extend in a direction inclined with respect to the horizontal. The one or more barriers may be planar. The one or more barriers may extend between one or more of the first container walls and one or more of the second container walls. Each sub-container may have a volume of at least 5% of the total volume of the (e.g. first) container, e.g. at least 10%, e.g. at least 20%. Each sub-container may have a volume of less than 80% of the total volume of the (e.g. first) container, e.g. less than 60%, e.g. less than 50%. It may be that each sub-container is the same size as each other sub-container, however this is not required. In an example, one or more (optionally each) of the plurality of sub-containers may have a (vertical) height of at least 5 meters, e.g. at least 20 meters, e.g. at least 40 meters. One or more (optionally) each of the plurality of sub-containers may have a (vertical) height of less than 100 meters, e.g. less than 75 meters, e.g. less than 60 meters. The or each barrier may comprise (e.g. be formed of) a relatively low acoustic impedance material. The or each barrier may comprise (e.g. be formed of) a sound absorbing material. The sub-containers may be stacked vertically (e.g. with a first sub-container positioned above a second sub-container, etc.). The agitators may be stacked vertically.

Where the sound emitter is particularly large, it is helpful to provide a particularly large container to (e.g. at least partially) surround the sound emitter. However, bubbles take some time to travel upwards under buoyancy (particularly in the case of very small bubbles where this may only occur after merging with other bubbles to thereby form larger bubbles), or in other directions as the fluid flows within the container. As such, if an agitator is provided only in one location within a large container, it can take a long time before sufficient bubbles are present throughout the liquid in the container for the transmission of sound to be effectively limited. By providing barriers within the container (and thus effectively dividing the container into a plurality of sub-containers) and providing an agitator within each sub-container, it is possible to reduce the time needed for sufficient bubbles to be provided. It is also noted that both bubble size and the speed of sound are pressure-dependent, and that pressure increase as a function of depth. Providing sub-containers as described herein can help to control for this.

The apparatus may comprise a pump configured to cause flow of liquid at the liquid surface. The pump may comprise a pump inlet in an upper portion of the container (e.g. at or near the liquid surface). The pump may comprise a pump outlet at or near the base of the container. There may be a conduit extending between the pump inlet and the pump outlet. The pump may be configured to cause the liquid to flow in a downward direction. The apparatus may comprise one or more pumps configured to cause flow of liquid within the container. Each sub-container may comprise a respective pump configured to cause flow of liquid, optionally at the top of the sub-container, e.g. in a downward direction.

The provision of a pump configured to cause flow of liquid at the liquid surface provides the advantage of allowing for bubbles buoyantly rising to the surface to be pushed back downwards into the container (e.g. by causing the fluid to flow in a downwards direction). This means that the fewer bubbles need to be replaced, and that the agitator can be operated less continuously, or at a lower rate, or that lower percentages of dissolved oxygen are required, or that lower concentrations of hydrogen peroxide are required, or that lower amounts of enzymes for the decomposition of hydrogen peroxide are required. In short, the use of such a pump allows for a more efficient apparatus.

The pump (or pumps) may be configured to displace at least 1 L per minute, e.g. at least 500 L per minute, e.g. at least 1000 L per minute (optionally in combination). The pump (or pumps) may be configured to displace up to 50,000 L per minute, e.g. up to 25,000 L per minute, e.g. up to 10,000 L per minute (optionally in combination). The skilled person will appreciate that the type and capacity of the pump may be selected in dependence on the size of container. For example, the pump may be configured to displace 100% of the volume of the container at least once every 30 minutes, e.g. at least once every 15 minutes, e.g. at least once every 10 minutes. The pump may be configured to displace 100% of the volume of the container at least once every 3 minutes, e.g. at least once every 5 minutes.

The agitator may be configured to cause sufficient bubbles to form that, in an (e.g. the) agitation region surrounding the agitator, the optical (e.g. light) intensity of (e.g. visible) light (e.g. in the wavelength range of 300 nm to 800 nm, e.g. 350 nm to 780 nm, e.g. 380 nm to 750 nm) having travelled through 10 centimetres of the liquid (in the agitation region) is reduced by at least 10% (e.g. at least 50%, e.g. at least 80%, optionally up to 99%) as compared to the intensity of that light before travelling through the liquid. The agitator may be configured to cause sufficient bubbles to form that, in an agitation region surrounding the agitator, the optical (e.g. light) intensity of (e.g. visible) light (e.g. in the wavelength range of 300 nm to 800 nm, e.g. 350 nm to 780 nm, e.g. 380 nm to 750 nm) having travelled through 10 centimetres of the liquid (in the agitation region) is reduced by at least 10% (e.g. at least 50%, e.g. at least 80%, optionally up to 99%) as compared to the intensity of that light travelling through 10 centimetres of liquid not containing any bubbles.

The skilled person will appreciate that the optical (e.g. light) intensity of light may be calculated according to the following equation:

$$I ( x ) = {I}_{0} {e}^{- {κ}_{v} ρ x}$$

Wherein x is the distance through the liquid (including any bubbles in the liquid), I(x) is the intensity of light at distance x, I₀ is the initial intensity of light at distance x=0, κᵥ is the opacity of the liquid, and ρ is the mass density of the liquid. Accordingly, in this context, optical (e.g. light) intensity should thus be understood as a function of the opacity of the medium through which the light travels. Liquid comprising a relatively higher density of (e.g. relatively small) bubbles has a higher opacity than liquid comprising a relatively lower density of (e.g. relatively small) bubbles. It should also be understood that liquid comprising a higher proportion of dissolved oxygen may have a different opacity to light when compared to liquid comprising a lower proportion of dissolved oxygen. Furthermore, where salt water (e.g. seawater) contains dissolved oxygen this may also have a different opacity to light than fresh water containing dissolved oxygen.

Where sufficient bubbles are generated that the optical (e.g. light) intensity of (visible) light is reduced as described hereinbefore, the inventor has found that the transmission of sound is also effectively limited.

However, it will also be appreciated that bubbles of small enough diameters may not (e.g. noticeably) alter the opacity of the liquid whilst still effectively attenuating sound waves. It has surprisingly been found that bubbles with diameters under 1 mm and in numbers which do not significantly alter the opacity of a 10-centimetre thickness of water still provide an attenuating effect. The apparatus (e.g. the agitator) may be configured to cause generation of bubbles with diameters under 1 mm (typically greater than 1 μm). The apparatus (e.g. the agitator) may be configured to cause sufficient bubbles to form that, in an (e.g. the) agitation region surrounding the agitator, the optical (e.g. light) intensity of (e.g. visible) light (e.g. in the wavelength range of 300 nm to 800 nm, e.g. 350 nm to 780 nm, e.g. 380 nm to 750 nm) having travelled through 10 centimetres of the liquid (in the agitation region) is reduced by less than 10% (e.g. less than 5%, e.g. less than 2%) as compared to the intensity of that light before travelling through the liquid.

The apparatus may comprise a (e.g. visible) light detector configured to output an indicator of the intensity of light having passed through a distance of the liquid. The apparatus may comprise a (e.g. visible) light emitter configured to emit light (e.g. which may then be detected by the light detector). The distance may be at least 5 centimetres, e.g. at least 10 centimetres, e.g. at least 20 centimetres. The distance may be a distance within the agitation region. The apparatus may comprise a sound detector configured to output an indicator of the intensity of sound transmitted outside the (e.g. first) container. The provision of such (a) light and/or sound detector(s) provides an indication of whether sufficient bubbles are being generated to effectively limit sound transmission. The provision of a sound detector provides an indication of the transmission of sound. Both detectors can be helpful for monitoring the operation of the apparatus, particularly by a user who may be remote from the apparatus.

The apparatus may comprise a controller. The controller may be configured to receive an (e.g. the) indicator of the intensity of (e.g. visible) light having passed through a (e.g. the) distance of the liquid (e.g. from the light detector); and regulate the amount of agitation caused by the agitator, responsive to the received indicator, to thereby maintain a target light intensity. The target light intensity may be within a range of light intensities. The range of light intensities may be between 90% and 10% of the intensity of (e.g. visible) light which has not passed through the distance of liquid, optionally between 80% and 20%, e.g. between 60% and 40%. The target light intensity may be below a threshold light intensity. The threshold light intensity may be 30% of the intensity of (e.g. visible) light which has not passed through the distance of liquid, or may be 20% of the intensity of (e.g. visible) light which has not passed through the distance of liquid, or may be 10% of the intensity of (e.g. visible) light which has not passed through the distance of liquid. The light detector may be configured to compare the intensity of light having passed through a (e.g. the) distance of liquid with the intensity of light of a reference beam, wherein the reference beam is a beam of light which has not passed through the liquid, optionally wherein the reference beam is a beam of light from the same light source as that of the light which has passed through the distance of liquid.

Where sufficient bubbles are present that light intensity is reduced as light passes through the liquid, this also indicates that transmission of sound through the liquid is limited. Agitation of the liquid by the agitator causes bubbles to form, and when agitation ceases the bubbles steadily leave the liquid (e.g. under buoyancy, e.g. via an opening in the container). Accordingly, by providing a controller as described herein, it is possible to arrange a feedback system, wherein the agitator is operated when light intensity increases above the threshold or outside the range (as this indicates fewer bubbles are present and thus that more sound could be transmitted) and wherein the agitator is not operated when light intensity is below the threshold or within the range (as this indicates more bubbles are present and thus that less sound can be transmitted). As this means it is not necessary to operate the agitator continuously, this makes the apparatus more efficient.

It may be that the gas (e.g. oxygen) bubbles form a gas (e.g. oxygen) bubble curtain. The gas (e.g. oxygen) bubble curtain may comprise gas (e.g. oxygen) bubbles formed as a result of agitation of the fluid by the agitator. It may be that the gas (e.g. oxygen) bubbles form a gas (e.g. oxygen) bubble curtain at least partially surrounding the sound emitter. The gas (e.g. oxygen) bubble curtain may be an annular gas (e.g. oxygen) bubble curtain, for example, a relatively higher density of gas (e.g. oxygen bubbles) may be found within an annular space (the gas (e.g. oxygen) bubble curtain) in the container than outside the annular space. It may be that at least twice (e.g. at least three times, e.g. at least five times, optionally less than 100,000 times) as many bubbles are present in the gas (e.g. oxygen) bubble curtain than are present outside the gas (e.g. oxygen) bubble curtain. The annular space may have an inner circumference, an outer circumference, and a height, and the sound emitter may be surrounded by the inner circumference. The thickness of the annular space (e.g. between the inner circumference and the outer circumference) may be at least 5 centimetres, e.g. at least 10 centimetres, e.g. at least 50 centimetres. The thickness of the annular space may be less than 10 metres, e.g. less than 5 metres, e.g. less than 1 metres. However, the skilled person will appreciate that an oxygen bubble curtain may be formed in substantially any shape (e.g. through the positioning of agitators and/or the positioning and use of pumps) and may be configured to either partially or wholly surround the sound emitter. For example, the oxygen bubble curtain may be a generally cuboid shape, having a length parallel to a base of the container, a height parallel to the height dimension of the container, and a width perpendicular to its height. The width of the oxygen bubble curtain (e.g. between the inner circumference and the outer circumference) may be at least 5 centimetres, e.g. at least 10 centimetres, e.g. at least 50 centimetres. The width of the oxygen bubble curtain may be less than 10 metres, e.g. less than 5 metres, e.g. less than 1 metre. The inventor has surprisingly found that the bubbles in the bubble curtain effectively limit the transmission of sound, even where the bubble curtain has a relatively low thickness or width (e.g. less than 50 centimetres).

The apparatus may be configured to produce sufficient bubbles to reduce sound transmission such that the sound pressure of sound emitted by the sound emitter having passed through the bubbles is at least 20 decibels lower than the sound pressure of sound emitted by the sound emitter before it has passed through the bubbles, e.g. at least 40 decibels, e.g. at least 60 decibels, e.g. at least 100 decibels. The apparatus may be configured to produce sufficient bubbles to prevent at least 60% by amplitude of sound from the sound emitter from being transmitted beyond the bubbles, e.g. at least 80% by amplitude, e.g. at least 90% by amplitude. The apparatus may be configured to produce sufficient bubbles to reduce by at least 60% the peak frequency of sound waves from the sound emitter from being transmitted beyond the bubbles, e.g. by at least 80%, e.g. by at least 90% by amplitude. The apparatus may be configured to produce sufficient bubbles that substantially no sound is transmitted from the sound emitter beyond the bubbles.

The controller may be configured to receive an (e.g. the) indicator of the intensity of sound outside the (e.g. first) container; and regulate the amount of agitation caused by the agitator, responsive to the received indicator of the intensity of sound, to thereby maintain a target sound intensity. The target sound intensity may be within a range of sound intensities. The range of sound intensities may be between 0 and 500 decibels, e.g. between 1 and 300 decibels, e.g. between 5 and 100 decibels. The target sound intensity may be below a threshold sound intensity. The threshold sound intensity may be less than 150 decibels, e.g. less than 80 decibels, e.g. less than 50 decibels, e.g. less than 20 decibels.

The apparatus may comprise a temperature sensor configured to output an indicator of the temperature of the liquid. The apparatus may comprise a heater configured to heat the liquid. The apparatus may comprise a heat regulator (e.g. comprising a heat exchanger) configured to regulate the temperature of the liquid. The heat regulator (e.g. heat exchanger) may transfer heat from within the container to liquid outside the container, or vice-versa. The apparatus may comprise a cooler configured to cool the liquid. The controller may be configured to: receive an (e.g. the) indicator of the temperature of the liquid; and regulate the amount of agitation caused by the agitator, responsive to the received indicator of the temperature of the liquid. This is helpful because the amount and size of bubbles generated by operation of the agitator may be temperature dependent. The controller may be configured to regulate the temperature of the liquid, e.g. responsive to the received indicator of the temperature of the liquid, optionally to thereby maintain a target temperature. The target temperature may be within a range of temperatures. The range of temperatures may be from 5° C. to 50° C. inclusive, e.g. from 10° C. to 30° C. inclusive, e.g. from 18° C. to 22° C. inclusive.

The apparatus may comprise a pH sensor configured to output an indicator of the pH of the liquid. The pH sensor may be calibrated for the salinity of liquid in the container. The controller may be configured to: receive an (e.g. the) indicator of the pH of the liquid; and regulate the amount of agitation caused by the agitator, responsive to the received indicator of the pH of the liquid. This is helpful because the amount and size of bubbles generated by operation of the agitator may be pH dependent.

The apparatus may comprise a pressure sensor configured to output an indicator of the pressure of the liquid, e.g. in the agitation region. The controller may be configured to: receive an (e.g. the) indicator of the pressure of the liquid; and regulate the amount of agitation caused by the agitator, responsive to the received indicator of the pressure of the liquid. This is helpful because the amount and size of bubbles generated by operation of the agitator may be pressure dependent.

The apparatus may comprise an oxygen detector configured to output an indicator of the percentage oxygen saturation of the liquid. The controller may be configured to: receive an (e.g. the) indicator of the percentage oxygen saturation of the liquid; and regulate the amount of agitation caused by the agitator, responsive to the received indicator of the percentage oxygen saturation of the liquid. This is helpful because the amount and size of bubbles generated by operation of the agitator may be dependent on the quantity of dissolved oxygen in the liquid.

The sound emitter may comprise a mechanical apparatus, for example a mechanical actuator. The sound emitter may comprise a mechanical machine. The sound emitter may comprise a marine piling apparatus. Marine piling apparatuses are particularly loud emitters of sound and the limitation of transmission of sound from marine piling equipment is particularly challenging. However, limiting the transmission of sound from such equipment represents significant benefits for marine life. In particular, marine mammals and some cetaceans can hear sounds of much higher frequencies than those within the human-audible frequency range, including some frequencies generated by marine piling (beyond those in the human-audible frequency range). As described herein, the sound emitter may emit sound waves having a peak frequency in the range 50 Hz to 200 kHz, inclusive, optionally 10 Hz to 300 kHz inclusive, optionally 5 Hz to 500 kHz, inclusive. The apparatus may be configured to limit transmission of sound waves having a peak frequency in the range 50 Hz to 200 kHz, inclusive, optionally 10 Hz to 300 kHz inclusive, optionally 5 Hz to 500 kHz, inclusive.

The sound emitter may comprise a valve, e.g. a control valve. For example, the sound emitter may comprise a valve (e.g. a control valve) of a gas distribution pipe. Gas distribution pipes can include very large valves (e.g. control valves) which in this role manage an energetic flow and emit significant noise under normal steady state operation.

The sound emitter may (e.g. be configured to) emit sound in the human audible frequency range. The sound emitter may (e.g. be configured to) emit ultrasound. The sound emitter may (e.g. be configured to) emit sound having a frequency below the human audible frequency range. For example, the sound emitter may (e.g. be configured to) emit sound waves having a peak frequency of at least 1 Hz, e.g. at least 20 Hz, e.g. at least 50 Hz. The sound emitter may (e.g. be configured to) emit sound waves having a peak frequency of less than 500 kHz, e.g. less than 200 kHz, e.g. less than 100 kHz. The sound emitter may (e.g. be configured to) emit sound waves having a peak frequency of between 50 Hz and 100 kHz inclusive, e.g. between 1 kHz and 50 kHz inclusive, e.g. between 10 kHz and 50 kHz inclusive. In an example, the sound emitter may (e.g. be configured to) emit sound waves in the frequency range 13 Hz to 3 kHz.

In some examples, bubbles at relatively deeper depths may be relatively smaller in diameter (e.g. on average, e.g. mean) and thus may be more relatively effective at limiting the transmission of sounds of relatively higher frequencies, whilst bubbles at relatively shallower depths may be relatively larger in diameter (e.g. on average, e.g. mean) and thus may be relatively more effective at limiting the transmission of sounds of relatively lower frequencies. The apparatus may be configured to limit the transmission of sound waves within a first frequency range at a first depth, and to limit the transmission of sound waves within a second frequency range (different to the first frequency range) at a second depth (different to the first depth). The first depth may be greater than the second depth. The first frequency range may be a higher frequency range than the second frequency range.

In some example embodiments, the container may comprise one or more barriers to thereby form a plurality of sub-containers as described herein. The plurality of sub-containers may comprise one or more deep sub-containers positioned at a relatively greater depth and one or more shallow sub-containers positioned at a relatively lesser (e.g. shallower) depth. Advantageously, this allows for a balance of bubbles under higher pressures (e.g. in the deep sub-containers), and thus smaller bubbles, to thereby maintain an absorption frequency range. Higher pressure at depth means smaller bubbles so higher frequency absorption.

The liquid (e.g. water, e.g. the aqueous solution) comprising at least 2% (e.g. at least 10%) dissolved oxygen by volume may be formed by combining water and hydrogen peroxide and allowing the hydrogen peroxide to decompose into water and oxygen (e.g. naturally). The liquid (e.g. water, e.g. the aqueous solution) comprising at least 2% (e.g. at least 10%) dissolved oxygen by volume may be formed by combining water, hydrogen peroxide, and an enzyme for the decomposition of hydrogen peroxide (e.g. catalase) and allowing the hydrogen peroxide to decompose into water and oxygen under action of the enzyme. The liquid (e.g. water, e.g. the aqueous solution) comprising at least 2% (e.g. at least 10%) dissolved oxygen by volume may be formed by forcing oxygen (optionally oxygen bubbles) into a liquid (e.g. water, e.g. an aqueous solution), optionally through the use of a mechanical system. The water comprising at least 2% (e.g. at least 10%) dissolved oxygen by volume may be formed by use of an oxygenation system, for example by infusion of oxygen with a membrane diffusing (e.g. oxygenation) system. The apparatus may comprise a membrane diffusing (e.g. oxygenation) system. Where the apparatus comprises a membrane diffusing (e.g. oxygenation) system, the bubbles may comprise oxygen bubbles, and/or nitrogen bubbles and/or air bubbles. The water comprising at least 2% (e.g. at least 10%) dissolved oxygen by volume may be formed by micro-bubbling system. The apparatus may comprise a micro-bubbling system. The water comprising at least 2% (e.g. at least 10%) dissolved oxygen by volume may be formed by use of a venturi system. The apparatus may comprise a venturi system.

The apparatus may comprise a gas (e.g. oxygen) tank. The apparatus may comprise one or more gas supply conduits extending between the gas (e.g. oxygen) tank and the membrane diffusing (e.g. oxygenation) system, each conduit comprising at least one valve configured to bring the gas (e.g. oxygen) tank into and out of fluid communication with the membrane diffusing (e.g. oxygenation) system. The apparatus may comprise one or more gas supply conduits extending between the gas (e.g. oxygen) tank and the micro-bubbling system, each conduit comprising at least one valve configured to bring the gas (e.g. oxygen) tank into and out of fluid communication with the micro-bubbling system. The apparatus may comprise one or more gas supply conduits extending between the gas (e.g. oxygen) thank and the venturi system, each conduit comprising at least one valve configured to bring the gas (e.g. oxygen) tank into and out of fluid communication with the venturi system.

The container may (e.g. completely) surround the sound emitter, e.g. in all directions, excluding the opening. For example, the second container walls may be configured to surround the sound emitter in all directions except where a first opening is provided and the first container walls may be configured to surround the second container walls in all directions except where a second opening is provided, and the first and second openings may be offset from each other. The first container walls may (e.g. completely) surround the sound emitter, e.g. in all directions, except where an opening is provided. The second container walls may (e.g. completely) surround the sound emitter, e.g. in all directions, except where an opening is provided. The container may comprise a closable opening. The container may comprise a door configured to open and close the opening.

Nevertheless, it will be understood that a container which is arranged to at least partially surround a sound emitter need not limit sound transmission in all directions. For example, it may be that the container is an open-topped cylinder, and thus that the sound transmission from the sound emitter is limited in downwards and lateral directions but not (or less so) in upward directions. Similarly, it may be that a container which is arranged to at least partially surround a sound emitter limits sound transmission in one direction, or across a range of angles outwards from the sound emitter. It is useful to provide a container in the form of a barrier, wherein the container limits sound transmission from the sound emitter into a particular space. The container may be provided in the form of a barrier. The apparatus (e.g. the container) may be configured to limit sound transmission from the sound emitter into a particular space.

Accordingly, a further aspect of the invention provides an apparatus for limiting transmission of sound from a sound emitter, the apparatus comprising: a sound barrier, the sound barrier comprising a container retaining a liquid, wherein the liquid comprises at least 2% (e.g. at least 10%) dissolved oxygen by volume; and an agitator configured to agitate the liquid, to thereby cause the formation of gas (e.g. oxygen) bubbles in the liquid. Advantageously, where there is a space near the sound emitter and it is preferable to limit sound entering the space, a sound barrier can be positioned between the sound emitter and the said space. The liquid and the bubbles will then limit the transmission of sound into the space.

A further aspect of the invention provides a method of limiting transmission of sound (e.g. in a liquid) from a sound emitter, the sound emitter being at least partially surrounded by a container (optionally a first container), the container retaining a liquid comprising at least 2% (e.g. at least 10%) dissolved oxygen by volume, and method comprising: causing agitation of (e.g. agitating) (e.g. at least a portion of) the liquid in the container to thereby cause the formation of gas (e.g. oxygen) bubbles in the liquid. Causing gas (e.g. oxygen) bubbles to form may comprise causing oxygen to be released out of the liquid to thereby form bubbles.

Agitation of liquid comprising at least 2% (e.g. at least 10%) dissolved oxygen by volume has been found to be a particularly effective method of causing the formation of sufficient bubbles to limit sound transmission in (e.g. through) a liquid.

The method may comprise receiving an indicator of the intensity of (e.g. visible) light having passed through a distance of the liquid, optionally from the light detector. The method may comprise regulating the amount of agitation caused, responsive to the received indicator, to thereby maintain a target light intensity. The target light intensity may be within a range of light intensities. The range of light intensities may be between 90% and 10% of the intensity of (e.g. visible) light which has not passed through the distance of liquid, optionally between 95% and 5%, optionally between 80% and 20%, e.g. between 60% and 40%. The target light intensity may be below a threshold light intensity. The threshold light intensity may be 30% of the intensity of (e.g. visible) light which has not passed through the distance of liquid, or may be 20% of the intensity of (e.g. visible) light which has not passed through the distance of liquid, or may be 10% of the intensity of (e.g. visible) light which has not passed through the distance of liquid. The method may comprise comparing the intensity of light having passed through a (e.g. the) distance of liquid with the intensity of light of a reference beam, wherein the reference beam is a beam of light which has not passed through the liquid, optionally wherein the reference beam is a beam of light from the same source as that of the light which has passed through the distance of liquid.

The method may comprise receiving an indicator of the intensity of sound outside the container (optionally outside a first container) and regulating the amount of agitation caused, responsive to the received indicator of the intensity of sound to thereby maintain a target sound intensity. The target sound intensity may be within a range of sound intensities. The range of sound intensities may be between 0 and 100 decibels, e.g. between 1 and 80 decibels, e.g. between 5 and 40 decibels. The target sound intensity may be below a threshold sound intensity. The threshold sound intensity may be less than 100 decibels, e.g. less than 50 decibels, e.g. less than 20 decibels.

The skilled person will appreciate that the size and quantity of the bubbles generated will depend on several factors including, but not limited to, the temperature of the liquid, the pH of the liquid, the pressure within the liquid, the oxygen saturation of the liquid, the rate at which the agitator agitates the liquid (e.g. the rate of flow of liquid caused by the agitator), the presence or absence of any substances in the liquid, the types and concentrations of any substances in the liquid (e.g. hydrogen peroxide, enzymes, surfactants), etc.

Accordingly, the method may comprise receiving an indicator of the temperature of the liquid. The method may comprise causing the temperature of the liquid to be regulated (e.g. responsive to the received indicator of the temperature of the liquid) to thereby maintain a target temperature. The target temperature may be within a range of temperatures. The range of temperatures may be from 5° C. to 50° C. inclusive, e.g. from 10° C. to 30° C. inclusive, e.g. from 18° C. to 22° C. inclusive. The method may comprise regulating the amount of agitation caused, responsive to the received indicator of the temperature of the liquid.

The method may comprise receiving an indicator of the pH of the liquid. The method may comprise regulating the amount of agitation caused, responsive to the received indicator of the pH of the liquid.

The method may comprise receiving an indicator of the pressure of the liquid, e.g. in the agitation region. The method may comprise regulating the amount of agitation caused, responsive to the received indicator of the pressure of the liquid.

The method may comprise receiving an indicator of the volume of liquid within the container. The method may comprise causing additional liquid to be supplied into the container. The method may comprise supplying additional liquid into the container. The method may comprise causing excess liquid to leave the container. The method may comprise removing excess liquid.

A further aspect of the invention provides a method of forming a liquid comprising water and at least 2% (e.g. at least 10%) dissolved oxygen by volume, as described hereinbefore, the method comprising: causing mixing of (e.g. mixing) water, hydrogen peroxide, and a catalyst for the decomposition of hydrogen peroxide.

It is easier to cause oxygen bubbles to form in water comprising at least 2% (e.g. at least 10%) dissolved oxygen (by volume) by agitation of the water, than it is to cause oxygen bubbles to form in water comprising lower percentages of dissolved oxygen.

The liquid may comprise at least 2% (e.g. at least 10%) dissolved oxygen by volume. The liquid may comprise at least 25% dissolved oxygen by volume, e.g. at least 50%, e.g. at least 75%, e.g. at least 80%. The liquid may comprise less than 100% dissolved oxygen, e.g. less than 99%, e.g. less than 90%. The liquid may have an oxygen saturation of at least 50%. The liquid may have an oxygen saturation of at least 80%. The liquid may have an oxygen saturation of at least 100%. The liquid may be supersaturated with oxygen, for example having an oxygen saturation above 100%. The liquid may have an oxygen saturation of at least 120%. The liquid may have an oxygen saturation of less than 200%, e.g. less than 150%. Oxygen is more readily released from liquid to thereby form oxygen bubbles when the liquid is agitated, where higher dissolved oxygen percentages are present in the liquid (e.g. in particular where the liquid comprises at least 10% dissolved oxygen by volume, although some effect is observed where the liquid comprises at least 2% dissolved oxygen by volume).

The controller may comprise one or more processors and a computer-readable memory (e.g. a non-transitory computer readable storage medium) storing instructions which, when executed by the one or more processors, cause the controller to perform the actions for which the controller is configured.

The sound emitter may be a sound emitter in a body of water (e.g. an ocean, sea, lake, loch, reservoir, pond, etc.) having a water surface and a floor (e.g. an ocean floor, sea floor, lake floor, etc.) The apparatus may be positioned in the body of water. The method may comprise installing the apparatus in the body of water. The liquid surface in the container may be higher than the water surface outside the container (e.g. as a result of the pressure of water acting on the container walls). Gas (e.g. oxygen) bubbles formed as a result of agitation of the liquid, and subsequently reaching the liquid surface may cause some liquid to be transferred out of the container (e.g. due to bubble jetting). In some examples, the sound emitter may emit sounds of sufficiently high sound pressure that the sound waves cause collapse of (e.g. at least a portion of) the bubbles in the liquid. The method may comprise supplying additional liquid and/or causing the formation of additional bubbles, to replace the collapsed bubbles. The apparatus may comprise a liquid supply conduit configured to supply additional liquid into the container (e.g. to replace liquid leaving the container as bubbles reach the liquid surface, and/or liquid leaving the container due to leaks in the container). The apparatus may comprise a liquid supply pump configured to supply additional liquid into the container, e.g. via the liquid supply conduit. The method may comprise causing additional liquid to be supplied into the container, optionally via a liquid supply conduit. The method may comprise supplying additional liquid into the container, optionally via a liquid supply conduit.

The apparatus may comprise a liquid volume detector configured to output an indicator of the volume of liquid within the container. The apparatus may comprise an excess liquid outlet. The opening may comprise (e.g. be) a (e.g. the) excess liquid outlet. The controller may be configured to: receive an (e.g. the) indicator of the volume of liquid within the container; and to cause additional liquid to be supplied into the container (e.g. via the liquid supply conduit, optionally by causing activation of the liquid supply pump) responsive to the received indicator of the volume of the liquid within the container indicating that the volume has fallen below a low liquid threshold. The low liquid threshold may be 95% of the capacity of the container, optionally 90% of the capacity of the container, optionally 85% of the capacity of the container. The controller may be configured to receive an (e.g. the) indicator of the volume of liquid within the container; and to cause excess liquid to leave the container (e.g. via the excess liquid outlet) responsive to the received indicator of the volume of the liquid within the container indicating that the volume has risen above a high liquid threshold. The high liquid threshold may be above 95% of the capacity of the container, e.g. above 98% of the capacity of the container, e.g. above 99% of the capacity of the container.

The apparatus may comprise one or more container supply conduits configured to (e.g. selectively) supply one or more substances (e.g. hydrogen peroxide, optionally an enzyme, etc) to the container. The controller may be configured to receive an (e.g. the) indicator of the temperature of the liquid and to regulate a supply of liquid into the container, responsive thereto, optionally via the liquid supply conduit, optionally using the liquid supply pump). The controller may be configured to receive an (e.g. the) indicator of the pH of the liquid and to regulate a supply of substances (e.g. liquid, salt, hydrogen peroxide, buffers, acids, bases, surfactants, enzymes, etc) into the container, responsive thereto (optionally via the one or more supply conduits, e.g. the liquid supply conduit, optionally using the liquid supply pump). The controller may be configured to receive an (e.g. the) indicator of the percentage oxygen saturation of the liquid and to regulate a supply of liquid (e.g. liquid comprising hydrogen peroxide) into the container, responsive thereto (optionally via the liquid supply conduit, optionally using the liquid supply pump). The controller may be configured to regulate a supply of hydrogen peroxide into the container, optionally in dependence on a predetermined rate of decomposition, e.g. to replace hydrogen peroxide that has decomposed. The rate of decomposition may be dependent on a number of factors, including but not limited to peak acoustic pressure of the sound emitted from the sound emitter.

The apparatus may comprise a wired communication link. The apparatus may comprise a wireless communication link. The apparatus may comprise a computer readable storage medium. The apparatus may be configured to transmit and/or receive data (e.g. information) via a wired communication link. The method may comprise transmitting and/or receiving data (e.g. information) via a wired communication link. The apparatus may be configured to transmit and/or receive data (e.g. information) via a wireless communication link. The method may comprise transmitting and/or receiving data (e.g. information) via a wireless communication link. The apparatus may be configured to transmit and/or receive data (e.g. information) via Wi-Fi™. The method may comprise transmitting and/or receiving data (e.g. information) via Wi-Fi™. Wi-Fi™ is a family of wireless network protocols, based on the IEEE 802.11 family of standards.

It will be understood that the liquid may be water, optionally water containing one or more other substances (e.g. salts, hydrogen peroxide, enzymes, buffers, surfactants, etc.). It will be understood that bubbles may be oxygen bubbles or may be air bubbles and may comprise nitrogen for example. It will be understood that where light is referred to, this means light in the visible spectrum. In addition, where sound or noise are referred to, this comprises sound in the human-audible range but is not limited to sounds in the human-audible range, and may extend to ultrasound, for example. The sound emitter may emit sounds comprising sound waves having a peak frequency in the range 50 Hz to 200 kHz, inclusive, optionally 10 Hz to 300 kHz inclusive, optionally 5 Hz to 500 kHz, inclusive. The apparatus may be configured to limit the transmission of sounds comprising sound waves having a peak frequency in the range 50 Hz to 200 kHz, inclusive, optionally 10 Hz to 300 kHz inclusive, optionally 5 Hz to 500 kHz, inclusive.

Marine piling apparatus may output sound in the form of a “shock pulse” (a sound typically caused by an impact and containing substantially all frequencies). As conventional bubble curtains generally produce bubbles of only one size, conventional bubble curtains are less effective than the bubble curtain provided by the present disclosure, as the bubble curtain provided by the present disclosure includes bubbles having a wide range of sizes and thus able to limit the transmission of sound (e.g. attenuate sound) of a wide range of frequencies. The vertical rise in the sound pressure level of a “shock pulse” from a marine piling apparatus can cause the collapse of bubbles. Accordingly, it may be that some time is required to cause formation of further gas bubbles in the liquid (e.g. as the result of agitation of the liquid by the agitator) so that the transmission of sounds of a subsequent shock pulse can then be limited (e.g. attenuated).

Accordingly, the apparatus may comprise a shock pulse detector configured to output an indicator of the detection of a shock pulse. The apparatus may be configured to receive an indication of the generation of a shock pulse, e.g. from marine piling apparatus, e.g. when a piling blow is carried out. The controller may be configured to: receive an (e.g. the) indicator of the detection (optionally generation) of a shock pulse and; send a signal to a marine piling apparatus (optionally a user thereof) to pause for a wait period before carrying out a (e.g. subsequent) piling blow. The wait period may be dependent on one or more of: a (e.g. the) indicator of the intensity of (e.g. visible) light having passed through a distance of liquid being below a threshold; a (e.g. the) indicator of the sound intensity outside the container being below a threshold; a (e.g. the) indicator of the pressure of the liquid; a (e.g. the) indicator of the temperature of the liquid; a (e.g. the) indicator of the pH of the liquid. The wait period may be at least 5 seconds, e.g. at least 10 seconds, e.g. at least 30 seconds, e.g. at least 1 minute, optionally less than 60 minutes, e.g. less than 30 minutes, e.g. less than 15 minutes.

The method may comprise receiving an indicator of the detection (optionally generation) of a shock pulse. The method may comprise causing a signal to be sent to a marine piling apparatus (optionally a user thereof) to pause for a wait period before carrying out a (e.g. subsequent) piling blow. The method may comprise sending a signal to a marine piling apparatus (optionally a user thereof) to pause for a wait period before carrying out a (e.g. subsequent) piling blow.

The apparatus may be configured to increase (or the method may comprise increasing) the proportion of dissolved oxygen by at least 2% by volume (e.g. at least 10%, e.g. at least 25%, e.g. at least 50%, e.g. at least 75%, e.g. at least 80%), over the proportion of dissolved oxygen present in the water without the use of the apparatus (or the method).

In some applications, the container may be omitted. Although this may lead to more rapid dissipation of dissolved oxygen and gas bubbles this may be acceptable in some use cases. Such rapid dissipation may for example be addressed by the provision of additional oxygen into the liquid, or the provision additional liquid comprising at least 2% (optionally at least 10%) dissolved oxygen by volume (e.g. in the vicinity of the agitator). The apparatus may be configured to allow the provision of additional oxygen into the liquid, and/or to allow to allow the provision of additional liquid comprising at least 2% (optionally at least 10%) dissolved oxygen by volume. For example, the apparatus may comprise a conduit configured to receive a fluid and supply that fluid towards the agitator. The method may comprise providing additional oxygen into the liquid, and/or providing additional liquid comprising at least 2% (optionally at least 10%) dissolved oxygen by volume. For example, the method may comprise supplying fluid towards the agitator, optionally via a conduit.

This in itself is regarded as inventive. Accordingly, a further aspect of the invention provides an apparatus configured to limit transmission of sound (e.g. through a liquid) from a sound emitter, the apparatus comprising a liquid, wherein the liquid comprises at least 2% (optionally at least 10%) dissolved oxygen by volume, and wherein the apparatus further comprises an agitator disposed in the liquid, the agitator configured to agitate (e.g. at least a portion of) the liquid proximal to the agitator, to thereby cause the formation of gas (e.g. oxygen) bubbles in the liquid. Optional features of other aspects described hereinabove may also be optional features of this further aspect.

A further aspect of the invention provides a method of limiting transmission of sound from a sound emitter, the sound emitter being at least partially surrounded a liquid comprising at least 2% dissolved oxygen by volume, and the method comprising: causing agitation of the liquid to thereby cause the formation of gas bubbles in the liquid. Optional features of other aspects described hereinabove may also be optional features of this further aspect.

It will be understood that steps of methods described hereinbefore with reference to any one particular method may be combined with any other herein-described method in substantially any combination, apart from those inherently incompatible. It will be further understood that the method steps may be performed in orders other than those described, and in some cases simultaneously, apart where this is inherently not possible. Features of any one aspect may be optional features of any other aspect.

### DESCRIPTION OF THE DRAWINGS

An example embodiment of the present invention will now be illustrated with reference to the following Figures in which:

FIG. 1 is a side elevation cross-sectional view diagram of a first example embodiment of an apparatus according to the invention;

FIG. 2 is a second side elevation cross-sectional view diagram of the first example embodiment of an apparatus according to the invention;

FIG. 3 is a side elevation cross-sectional view diagram of a second example embodiment of an apparatus according to the invention;

FIG. 4 is a side elevation cross-sectional view diagram of a third example embodiment of an apparatus according to the invention;

FIG. 5 is a plan elevation view diagram of a further example embodiment of an apparatus according to the invention;

FIG. 6 is a flow chart of steps in a method according to an example embodiment of the invention;

FIG. 7 is a schematic illustration of an apparatus according to an example embodiment of the invention; and

FIG. 8 is a plot of the speed of sound through a fluid.

### DETAILED DESCRIPTION OF AN EXAMPLE EMBODIMENT

It will be understood by those skilled in the art that any dimensions and relative orientations such as lower and higher, above and below, and directions such as vertical, horizontal, upper, lower, longitudinal, axial, radial, lateral, circumferential, etc. referred to in this description refer to, and are within expected structural tolerances and limits for, the technical field and the apparatus and methods described, and these should be interpreted with this in mind.

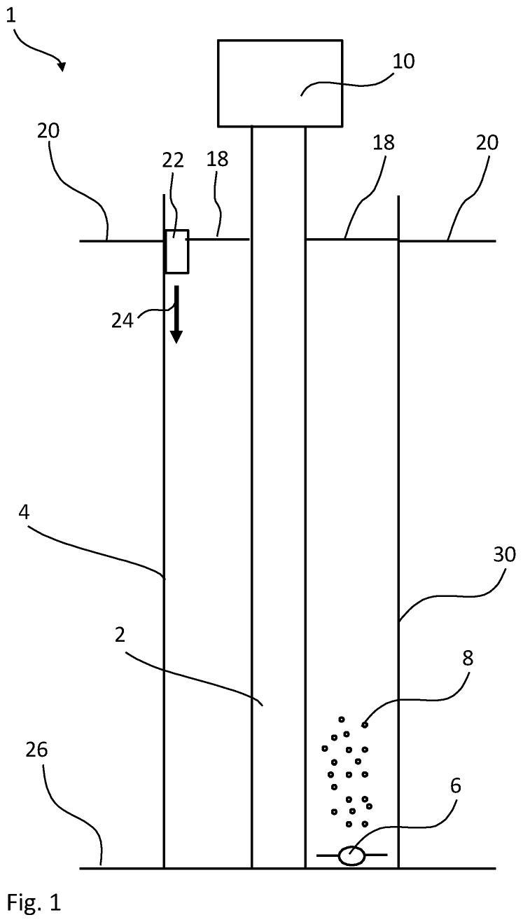

FIG. 1 is a side elevation view diagram of a first example embodiment of an apparatus 1 according to the invention. Here, the sound emitter 2 is a marine pile, part of a set of marine piling equipment 10. A container 4 has been arranged to surround the marine pile 2, the container 4 being filled with liquid, in this case sea water comprising 50% dissolved oxygen, by volume. In the lower portion of the container 4 there is provided an agitator in the form of a mixer 6 which, when in use, agitates the fluid to thereby cause oxygen to be released from the water and form bubbles 8. At the top of the container 4 there is provided a pump 22 configured to cause liquid near the top of the container and near the liquid surface 18 to flow in a downwards direction, as indicated by arrow 24. In FIG. 1 the mixer 6 has been operated for only a few seconds and therefore a relatively small number of bubbles have been generated.

The marine pile 2 is partially submerged in the liquid in the container, in that approximately 85% of the marine pile 2 is below the liquid surface 18. The container 4 is in turn partially surrounded by the sea, and thus by sea water. The container 4 extends from above the sea water surface 20 to the sea floor 26. The container 4 has a cylindrical outer wall 30, however it is open at its base and at its top. The cylindrical outer wall 30 is provided with weights (not shown) which weigh the wall down, bringing it sealedly into contact with the sea floor 26. The sea floor 26 may thus in this instance be thought of as providing the base of the container 4. The open top provides an opening in the container 4, via which bubbles 8 may leave the container, e.g. as they rise through the liquid under buoyancy. The outer cylindrical wall 30 of the container 4 extends both above the liquid surface 18 and above the sea water surface 20. The liquid surface 18 is slightly above the sea water surface 20 in this instance, because the fluid is slightly less dense than the sea water, and therefore hydrostatic forces act on the container 4 (which is slightly flexible), thereby compressing it slightly and causing a hydrostatic head in the container 4.

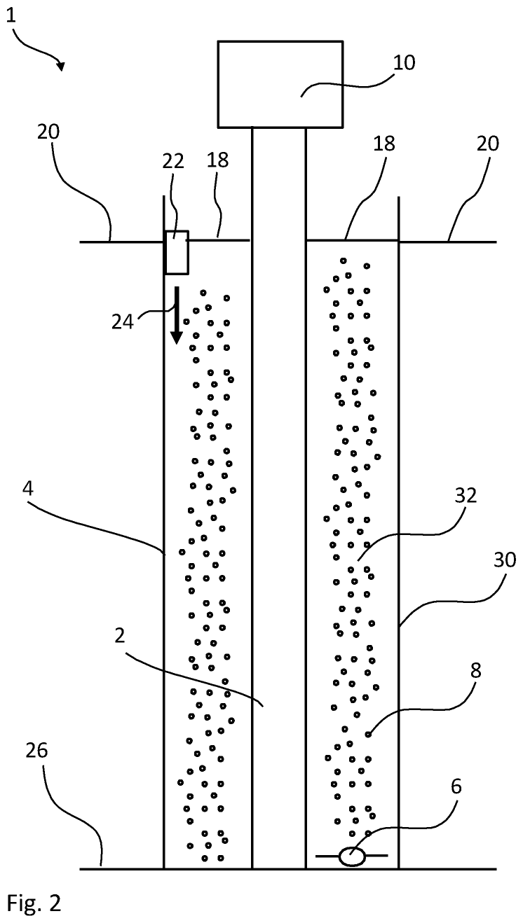

FIG. 2 is a second side elevation view diagram of the first example embodiment of the apparatus 1. Here, the mixer 6 has been in operation for a longer period (^{˜}60 minutes) and as a result a larger number of bubbles 8 have formed. The bubbles 8 are continuously formed as a result of the mixer 6 agitating the fluid. The bubbles 8 tend to float upwards through the fluid due to buoyancy. As the bubbles 8 approach the fluid surface 18 the flow caused by the pump 22 tends to cause a portion of the bubbles 8 to move back downwards through the fluid, rather than allowing all bubbles 8 to leave the fluid as they reach the fluid surface 18. As a result, an annular bubble curtain 32 has formed, which partially surrounds the marine pile (i.e. the portion of the pile which is beneath the liquid surface 18 is radially surrounded by the bubble curtain 32).

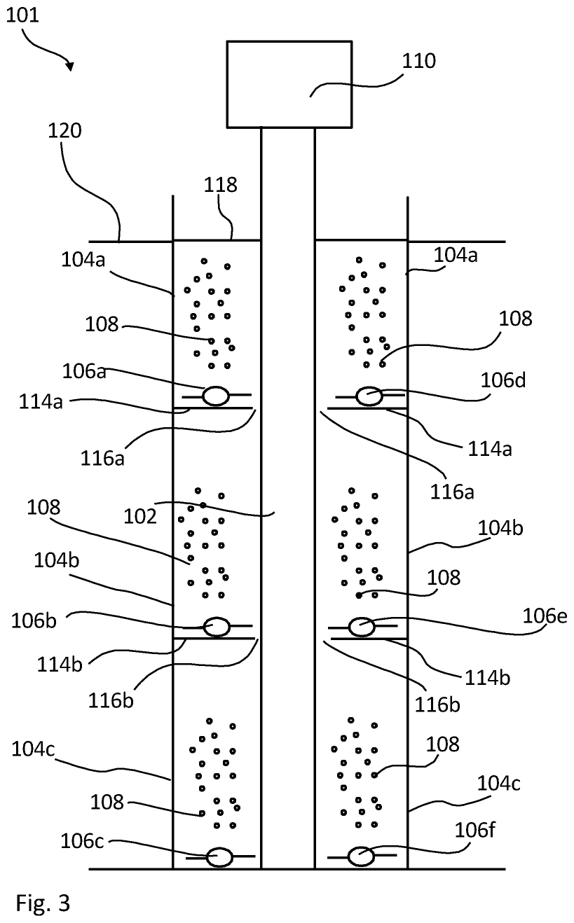

FIG. 3 is a side elevation cross-sectional view of a second example embodiment of an apparatus 101 according to the invention. As with the embodiment of FIGS. 1 and 2, the apparatus 101 includes a container arranged to surround the sound emitter (again in the form of marine piling equipment 110) and the container is filled with liquid. In this instance, the container has two horizontal barriers 114a, 114b, each in the form of a flat disc with a central hole 116a, 116b. The horizontal barriers 114a, 114b each extend partway across the interior of the container, from the interior side of the cylindrical wall towards the central part of the container, with the hole 116a, 116b surrounding the marine pile, such that there is a space between each barrier 114a, 114b and the pile. The container may thus be understood to be made up of three sub-containers 104a, 104b, 104c. Each sub-container 104a, 104b, 104c is provided with two mixers 106a, 106b, 106c, 106d, 106e, 106f which, when in use, agitate the fluid in the respective sub-container 104a, 104b, 104c to thereby cause oxygen to be released from the water and form bubbles 108.

Barrier 114b forms the top of the lowermost container 104c and, as the barrier 114b has the hole 116b surrounding the pile, arranged so as to provide a space between the pile and the barrier 114b, bubbles 108 reaching the top of the sub-container 104c can leave the sub-container 104c and move into the middle sub-container 104b via the hole 116b. Similarly, barrier 114a forms the top of the middle sub-container 104b and, as the barrier 114a as the hole 116a surrounding the pile, arranged so as to provide a space between the pile and the barrier 114a, bubbles 108 reaching the top of sub-container 104b can leave the sub-container 104b and enter the uppermost sub-container 104a via the hole 116a. The uppermost sub-container 104a is open at its top surface and thus bubbles 108 reaching the top of the uppermost sub-container 104a can leave at the liquid surface 118. At the top of each sub-container 104a, 104b, 104c there is provided a pump (not shown) configured to cause liquid near the top of each respective sub-container 104a, 104b, 104c and near the liquid surface 118 to flow in a downwards direction. In FIG. 3 each mixer 106a, 106b, 106c, 106d, 106e, 106f has been operated for only a few seconds and therefore a relatively small number of bubbles have been generated by each mixer 106a, 106b, 106c, 106d, 106e, 106f. However, as each sub-container 104a, 104b, 104c is smaller than the container 4 of FIGS. 1 and 2, and as each sub-container is provided with two mixers 106a, 106b, 106c, 106d, 106e, 106f, a significantly larger quantity of bubbles can be generated per litre of liquid, and in a relatively short time.

As with FIGS. 1 and 2, the marine pile is partially submerged in the liquid in the container, in that approximately 85% of the marine pile is below the liquid surface 18. The container is in turn partially surrounded by the sea, with sub-containers 104b and 104c being surrounded by the sea and sub-container 104a being partially surrounded by the sea and partially extending above the sea surface 120. The container extends from above the sea water surface 120 to the sea floor. The container has a weighted cylindrical outer wall, however it is open at its base and at its top. The sea floor may thus in this instance be thought of as providing the base of the lowermost sub-container 104c. The open top provides an opening in the uppermost sub-container 104a, via which bubbles 8 may leave the container, e.g. as they rise through the liquid under buoyancy. The outer cylindrical wall of the container extends both above the liquid surface 118 and above the sea water surface 120.

In use, the mixer 6, 106a, 106b, 106c, 106d, 106e, 106f, is switched on and begins agitating the fluid in the container 4 or sub-container 104a, 104b, 104c. As the fluid is agitated, the oxygen dissolved in the fluid is released from the fluid, thereby forming bubbles 8, 108. The bubbles 8, 108 travel upwards in the fluid and in the container 4 or sub-container 104a, 104b, 104c towards the liquid surface 18, or the top of the sub-container 104b, 104c. At the liquid surface 18, or the top of the sub-container 104b, 104c, the flow caused by the pump 22 (not shown in FIG. 3), causes the liquid and a portion of the bubbles 8, 108, therein to travel in a downwards direction, as indicated by arrow 24 (not shown in FIG. 3). The bubbles 8, 108 thereby circulate within the container 4 or sub-container 104a, 104b, 104c and a bubble curtain 32 is formed (or may be formed in each respective sub-container), surrounding the sound emitter 2.

When the bubble curtain 32 has been formed, the sound emitter (here the marine pile) 2 may be activated. Sound travels outwards from the sound emitter 2, and most especially from the point where the marine pile 2 meets the sea floor 26. Sound waves travel through the liquid until they meet the bubble curtain 32. When the sound waves reach the bubble curtain 32, they repeatedly pass through and are scattered by multiple liquid-gas boundaries. Each bubble 8, 108 encountered by a sound wave represents two such boundaries (a first boundary as the sound wave travels from the liquid into the gas of the bubble 8, 108, and a second as the sound wave travels from the gas of the bubble 8, 108 back into the liquid surrounding the bubble 8, 108). Without wishing to be bound by theory, the inventor believes that sound transmission is limited as a result of the scattering and absorption of the sound waves that takes place at each such interface, with the result that sound energy is absorbed and the sound is attenuated after a high number of interactions with bubbles 8, 108 in the bubble curtain 32. As a result, very little sound is able to travel all the way through the bubble curtain 32 and escape beyond the container 4 (or sub-container 104a, 104b, 104c) and into the sea.

Marine piling can produce pressures of 180 decibels and above at 750 metres from the marine pile. This is harmful to marine life. The bubbles 8, 108 generated by operation of the apparatus 1, 101, 201 limit the transmission of sound, such that the sound pressure on the other side of the bubbles 8, 108 to the sound emitter 2 is reduced by 40 decibels compared to the sound pressure on the same side of the bubbles 8, 108 as the sound emitter 2. Accordingly, application of the apparatus 1, 101, 201 is beneficial to marine life and leads to a reduced environmental acoustic footprint.

When the marine piling operation has been completed (or is paused) the mixer 6, 106a, 106b, 106c, 106d, 106e, 106f and pump 22 are stopped. Bubbles 8, 108 steadily leave the fluid and the container 4 as they rise to the fluid surface 18, 118 under buoyancy. If no further marine piling is required, the apparatus 1, 101 can be removed, and optionally moved to the next marine pile 2.

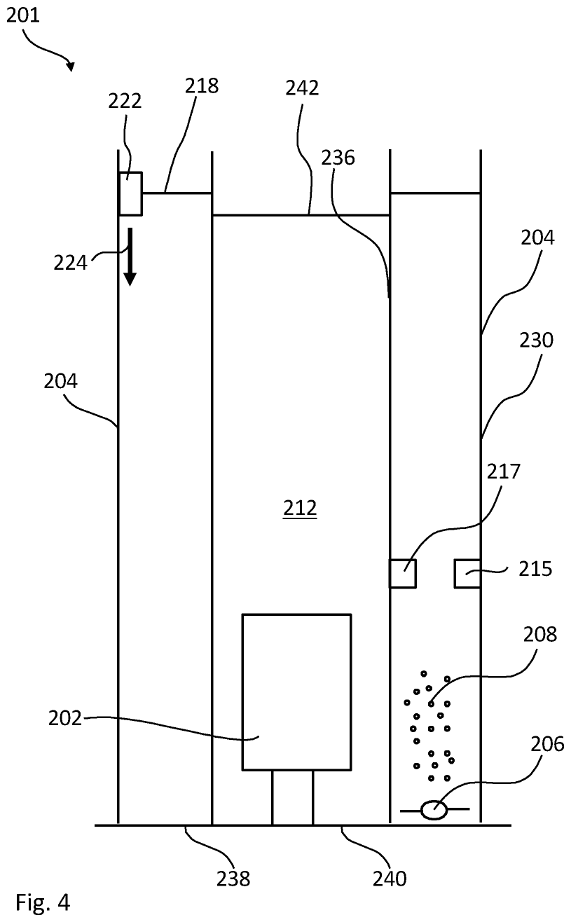

FIG. 4 is a side elevation cross-sectional view of a third example embodiment of an apparatus 201 according to the invention. As with the embodiment of FIGS. 1, 2, and 3 the apparatus 201 includes a container 204 arranged to surround the sound emitter 202 (here a generator), the container 204 being filled with liquid. In this instance, the container 204 is an annular outer container 204 with an interior space 212 which is filled with air. The interior space 212 may be considered as an inner cylindrical container 212 which retains the sound emitter 202. The outer container 204 is provided with an agitator in the form of a mixer 206 which, when in use, agitates the fluid in the outer container 204 to thereby cause oxygen to be released from the water and form bubbles 208.

At the top of the outer container 204 there is provided a pump 222 configured to cause liquid near the liquid surface 218 to flow in a downwards direction as indicated by arrow 224. In FIG. 4 the mixer 206 has been operated for only a few seconds and therefore a relatively small number of bubbles have been generated.

In this example embodiment, the sound source is within the inner container 212, which is in turn partially surrounded by the outer container 204 and thus by the liquid in the outer container 204. The outer container 204 has an outer cylindrical wall 230, an inner cylindrical wall 236 and a base 238, however it is open at its top. The inner cylindrical wall 236 of the outer container 204 forms the cylindrical wall of the inner container 212. The inner container 212 also has a base 240 and an upper wall 242. The open top of the outer container 204 provides an opening in the outer container 204, via which bubbles 208 may leave the outer container 204, e.g. as they rise through the liquid under buoyancy. The outer cylindrical wall 230 of the outer container 204 extends above the liquid surface 218.

The apparatus 201 also has a light detector 215 (here a photodetector) and a light source 217 (here in the form of an LED) positioned within the outer container 204. The light detector 215 is configured to detect light emitted by the LED 217 and output an indicator of the intensity of light detected. The distance between the light detector 215 and the LED 217 is 20 centimetres. The apparatus 201 also has a controller (not shown) configured to receive the indicator of the intensity of light detected and regulate the amount of agitation caused by the mixer 206, responsive to the received indicator to thereby maintain a target light intensity.

The bubbles 208 are continuously formed as a result of the mixer 206 agitating the fluid. The bubbles 208 tend to float upwards through the fluid due to buoyancy. As the bubbles 208 approach the liquid surface 218 the flow caused by the pump 222 tends to cause a portion of the bubbles 208 to move back downwards through the fluid, rather than allowing all bubbles 208 to leave the fluid as they reach the fluid surface 218. As a result, an annular bubble curtain (not shown in FIG. 4) forms in the outer container 204, and thus the sound emitter 202 is partially surrounded by the bubble curtain.

Sound waves travel from the sound emitter 202, through the air in the inner container 212 until they reach the inner cylindrical wall 236. The sound waves travel through the inner cylindrical wall 236 and enter the fluid within the outer container 204 and continue travelling through this fluid until they reach the bubble curtain. Here, the sound waves are absorbed and scattered by the bubbles 208, similarly to the case as described in relation to FIGS. 1, 2, and 3. The mixer 206 and pump 224 may be operated continuously or may be operated only when the sound emitter 202 is emitting sound.

Light travels from the LED 217, through the liquid in the outer container 204 and is scattered by the bubbles. Accordingly, when the mixer 206 is not in operation (and thus relatively fewer bubbles are present) less scattering of the light occurs and more light will be detected by the light detector 215. The light detector 215 will therefore output an indication of a relatively higher intensity of light being detected. Conversely, when the mixer 206 is in operation (and thus relatively more bubbles are present) more scattering of the light occurs and the light detector 215 will therefore output an indication of a relatively lower intensity of light being detected.

If bubbles are not present to scatter light, they are also not present to scatter sound. Accordingly, when the controller receives an indication that the intensity of light received by the light detector 215 is below a threshold, the controller causes the degree of agitation caused by the mixer 206 to be increased (for example, by increasing the speed of the mixer 206). When the controller receives an indication that the intensity of light received by the light detector 215 is above a threshold, the controller causes the degree of agitation caused by the mixer 206 to be decreased (for example by decreasing the speed of the mixer 206) or stopped. In this way, it is possible to operate the apparatus 201 in a more efficient way, as it is not necessary to continually operate the mixer 206. In an example, it is has been found that it is possible to pause the mixing of the mixer 206 for 20 seconds before an increased intensity of light is detected, at which point the mixer can be caused to mix the fluid until the intensity of light is found to have decreased again.

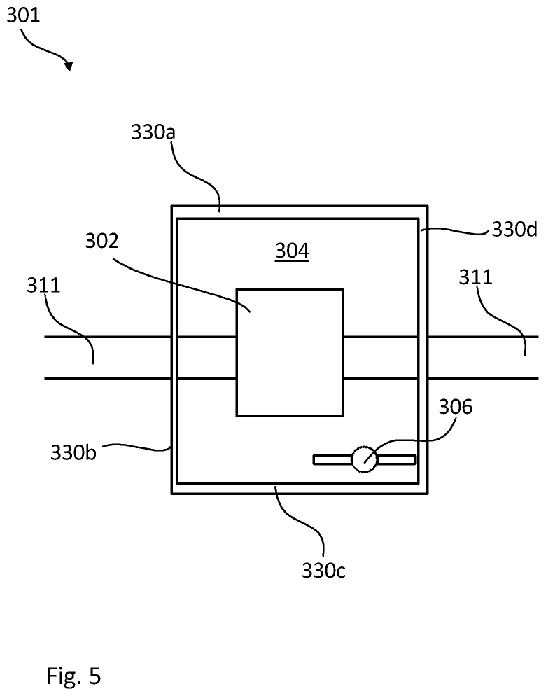

FIG. 5 is a plan elevation view diagram of a further example embodiment of an apparatus 301 according to the invention. As with the embodiment of FIGS. 1 to 4 the apparatus 301 includes a container 304 arranged to surround the sound emitter 302, the container 304 being filled with liquid. In this instance the container is an open-topped cuboid with four vertical side walls 330a, 330b, 330c, 330d and a base (not shown). The container 304 is provided with an agitator in the form of a mixer 306 which, when in use, agitates the fluid in the container 304 to thereby cause oxygen to be released from the water and form bubbles (not shown in FIG. 5). At the top of the container 304 there is provided a pump (not shown in FIG. 5) configured to cause liquid near the liquid surface to flow in a downwards direction.

In this instance, the sound emitter 302 is a control valve 302 of a gas distribution pipe 311. The container has apertures to allow for the ingoing and outgoing pipe 311. The container 304 is sealed at the apertures, around the pipe 311, so that no liquid can leave the container therethrough.

Bubbles are continuously formed as a result of the mixer 306 agitating the fluid. The bubbles tend to float upwards through the fluid due to buoyancy. As the bubbles approach the top of the container 306 the flow caused by the pump tends to cause a portion of the bubbles to move back downwards through the fluid, rather than allowing all bubbles to leave the fluid as they reach the fluid surface. As a result, a bubble curtain (not shown in FIG. 5) forms in the container 304, and thus the sound emitter 302 is partially surrounded by the bubble curtain. Sound waves travel from the sound emitter 302, through the fluid within the container 304 and continue travelling through this fluid until they reach the bubble curtain. Here, the sound waves are absorbed and scattered by the bubbles, similarly to the case as described in relation to FIGS. 1, 2, and 4. This is particularly helpful in limiting the sound transmission from the control valve 302 into the air that would otherwise surround the control valve. Without the apparatus 301 the control valve 302 would be default be surrounded by air, which can lead to Helmholtz resonance.

The average (mean) diameter of the bubbles 8, 108, 208 is 0.05 cm, when considered in terms of the maximum size a bubble 8, 108, 208 will have from the instant it is generated to 3 seconds after it has been generated. Subsequently to this, the bubbles 8, 108, 208 will typically vary in size, particularly as they move upwards through the liquid. The bubble curtain 32 contains at least 1,000 bubbles in each 1 Litre volume where the bubble curtain 32 is present. However the skilled person will appreciate that relatively more bubbles 8, 108, 208 will typically be present closer to the mixer(s) 6, 106a, 106b, 106c, 106d, 106e, 106f, 206, 306 and that, over time, bubbles 8, 108, 208 will disperse somewhat so that fewer bubbles 8, 108, 208 will be present further from the mixer(s) 6, 106a, 106b, 106c, 106d, 106e, 106f, 206, 306.

The walls of the containers 4, 104, 204 are formed of tarpaulin with a reinforced webbing layer. The walls of container 304 is formed of high density polyethylene (HDPE). The or each mixer 6, 106a, 106b, 106c, 106d, 106e, 106f, 206, 306 is a paddle stirrer having two steel paddles which are rotatable about an axis via an electric motor at 100 rpm. The pump 22, 222 is a positive displacement pump configured to displace 1000 L per minute (although the skilled person will appreciate that the choice of pump will depend on the size of the container). The barriers 114a, 114b (where present) are formed of HDPE discs.

The liquid in the container 4, 104, 204, 304 is water comprising 50% dissolved oxygen by volume. The water also contains 20 mg/L of hydrogen peroxide and 5 kU of catalase per 1 litre of water. The catalase causes the decomposition of hydrogen peroxide into water and oxygen. Some of the oxygen immediately forms additional bubbles, whilst some dissolves into the water and may form additional bubbles as the liquid is agitated by the mixer 6, 106a, 106b, 106c, 106d, 106e, 106f, 206, 306. The catalase increases the rate at which the hydrogen peroxide is decomposed. The mixer 6, 106a, 106b, 106c, 106d, 106e, 106f, 206, 306 prevents the catalase from settling at the base of the container, and keeps it in suspension, which improves the efficiency with which the catalase acts on the hydrogen peroxide.

Advantageously, the formation of oxygen bubbles 8, 108, 208 in the liquid limits the transmission of the sound through the liquid. Agitation of liquid comprising at least 50% dissolved oxygen by volume has been found to be a particularly effective way to cause the formation of bubbles 8, 108, 208, as some of the oxygen dissolved in the liquid is released from the liquid to thereby form a large quantity of oxygen bubbles 8, 108, 208 as the liquid is agitated. Thus bubbles 8, 108, 208 can be formed without the use of compressors or similar devices to force gas bubbles through the liquid, and the apparatus, 1, 101, 201, 301 is therefore also more efficient than would be the case if a compressor were used.

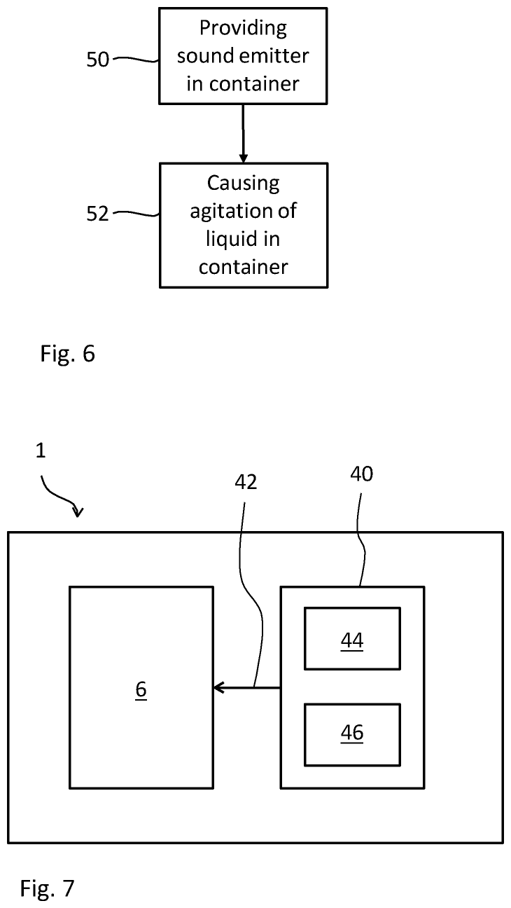

FIG. 6 is a flow chart of steps in a method according to an example embodiment of the invention. Here the steps include providing 50 a sound emitter in a container and 52 causing agitation of the liquid in the container.

FIG. 7 is a schematic illustration of an apparatus 1 according to an example embodiment of the invention. The apparatus 1 has at least one mixer 6 and a controller 40. The controller 40 is configured to send signals 42 to the mixer 6. The controller 40 is also typically configured to transmit data elsewhere, for example to further components of the apparatus 1, and/or to devices external to the apparatus 1, via a wireless data connection. The signals 42 include signals generated by the controller 40 in dependence on data received by the controller 40, for example from user inputs and/or from the light detector 215. The controller 40 in this example is realised by one or more processors 44 and a computer-readable memory 46. The memory 46 stores instructions which, when executed by the one or more processors 44, cause the apparatus 1 to operate as described herein. Although the controller 40 is shown as being part of the apparatus 1, it will be understood that one or more components of the controller 40, or even the whole controller 40, can be provided separate from the apparatus 1. For example, the controller may be remote from the apparatus 1 and may exchange signals with the mixer 6 by wireless communication.

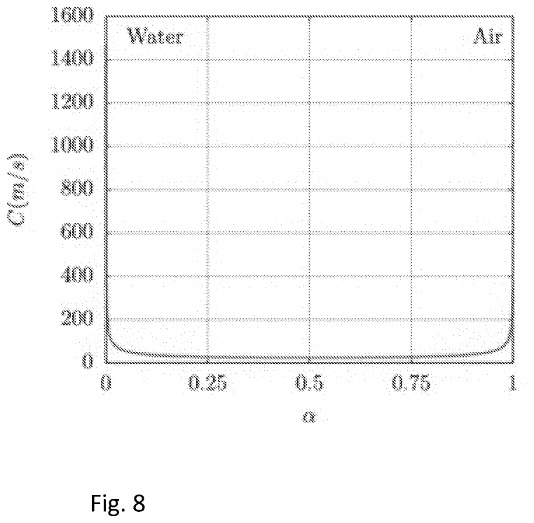

FIG. 8 is a plot of the speed of sound through a fluid, as a function of the proportion of water vs air in that fluid. As can be seen from this figure, the speed of sound is relatively high in 100% water and also relatively high in 100% air, however, the speed of sound is relatively low where the fluid is a combination of water and air. The reduction in the speed of sound has the result that sound of a given frequency has a correspondingly lower wavelength in a fluid containing a mixture of water and air, than it would in a fluid made up only of water, or a fluid made up only of air. This in turn changes the way in which the sound can be attenuated, either by individual bubbles, or by a bubble curtain (e.g. a bubble curtain generated by mixing of a liquid containing a high proportion of dissolved oxygen to thereby form bubbles, as herein described).

Although in the examples described hereinabove the agitator 6, 106, 206, 306 is provided in the form of a mixer, this is not required, and other means may be used to agitate the liquid in the alternative. For example, in some embodiments, the agitator may be a bubble curtain generator in the form of a compressor connected to a perforated pipe to thereby force bubbles through the liquid. The compressor may be a single compressor or may be provided by a group of (e.g. 7 bar) compressors, together outputting 10,000 L/min. The compressor may be arranged to create a bubble curtain at the lower outer perimeter of the container. The use of a bubble curtain generator to agitate the liquid allows for an even greater number of bubbles to be generated in the liquid (i.e. some arising as a result of the agitation causing dissolved oxygen to be released from the liquid and to thereby form bubbles, and some from the bubble curtain generator itself). A higher number of bubbles provides more effective sound attenuation and more effectively limits sound transmission.

### Summary of Experimental Testing

The inventor carried out a test of an example of the apparatus and methods as described herein. The following summary of this test provides a nonlimiting example of how the apparatus and methods may be used.

A 3 m³ container was formed with tarpaulin container walls and this container was filled an aqueous solution, in this case seawater. 30 L of hydrogen peroxide was added to the container along with 100 ml of catalase (which encourages decomposition of hydrogen peroxide). A mixer (in this case an air mixer) was operated for 2 minutes, leading to the generation of a large number of buoyant bubbles, with an approximate average (mean) diameter of 5 mm. The resulting fluid was transparent.

A sound emitter in the form of a frequency generator was activated and caused to apply 10 ms sound pulses at approximately 190 dB frequency pulses. The pulses started at approximately 2 kHz and were increased in ^{˜}500 Hz steps up to approximately 13 kHz, with 100 ms between each pulse.

Hydrophones were used to record sound at 0.5 m, 1 m, and 2 m distances from the sound emitter, through the aqueous solution at 1 m and 2 m depths. Following the 2-minute activation time of the mixer, the sound level was not measurable with the hydrophones for a period in excess of 2 hours. It was however found that sound way discernible by replaying with amplification. By this method, it was possible to confirm that attenuation increased as a function of increasing distance (i.e. the distance the soundwaves travelled through the fluid).

Over the 2-hour period, it was also found that the concentration of hydrogen peroxide decreased by approximately 27%. In this test, it was also noted that attenuation effect was greatest at shallower depths, with the sound being detected by the deeper hydrophones sooner than by the shallower hydrophones. It should be noted that speed of sound is a function of pressure (and that pressure is greater at greater depths), and that bubble size is also a function of pressure (with higher pressures leading to smaller bubbles). It has further been observed that, at least in some cases, the attenuation effect is observed at shallower depths before it is observed at greater depths (corresponding to the effect also ending sooner at greater depths). The skilled person will thus appreciate that depth and buoyancy are just two of several parameters to be considered when seeking to put the invention into effect. It should also be understood that the rate of dissolved gas production is believed to be dependent on (e.g. at least) the hydrogen peroxide concentration, the quantities of enzymes (e.g. catalase) present, and the presence or absence (and quantities) of any biomass (e.g. fish).

It was noted that wave action on the tarpaulin provided a gentle movement of the fluid and that this provided further mixing during the test, likely contributing the relatively long period during which sound attenuation was effective.

Further tests with frequent mixing gave similar attenuation but initial results suggest that some mixing regimes may lead to less stable fluid conditions (e.g. with more variation in the numbers of bubbles, etc). That said, it also appears that varying the concentrations of hydrogen peroxide and catalase, will also effect stability of the fluid in this sense (i.e. in addition to the mixing).

The attenuation effect appears to be most significant with smaller gas bubbles rather than larger gas bubbles. The attenuation achieved was found to be greater than previous noise mitigation strategies (e.g. simple bubble curtains). It was surprisingly found that excessive mixing may in some circumstances reduce the effectiveness of the sound attenuation. An optimal rate of mixing to encourage hydrogen peroxide decomposition (and thus bubbles and dissolved oxygen), without reducing the effect, will depend on the conditions within the liquid.

Throughout the description and claims of this specification, the words “comprise” and “contain” and variations of them mean “including but not limited to”, and they are not intended to and do not exclude other components, integers, or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, or groups described in conjunction with a particular aspect, embodiment, or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

In summary, there is provided apparatus (1) for limiting transmission of sound from a sound emitter (2), the apparatus comprising a container (4) arranged to at least partially surround a sound emitter, the container retaining a liquid, wherein the liquid comprises at least 2% dissolved oxygen, and wherein the apparatus further comprises an agitator (6) configured to agitate the liquid, to thereby cause the formation of gas bubbles (8) in the liquid.

1. Apparatus for limiting transmission of sound from a sound emitter, the apparatus comprising a container arranged to at least partially surround a sound emitter, the container retaining a liquid,
wherein the liquid comprises at least 2% dissolved oxygen by volume, and
wherein the apparatus further comprises an agitator configured to agitate the liquid, to thereby cause the formation of gas bubbles in the liquid.

2. Apparatus according to claim 1, wherein the container has at least one opening defined therein, such that the bubbles can leave the container via the opening.

3. Apparatus according to claim 1, wherein the agitator comprises a bubble curtain generator, optionally arranged to generate a bubble curtain at least partially surrounding the sound emitter.

4. Apparatus according to claim 1, wherein the container retains the sound emitter, and wherein the sound emitter is submerged in the liquid.

5. Apparatus according to preceding claim 1, wherein
the container is a first container comprising one or more first container walls,
wherein the apparatus comprises a second container comprising one or more second container walls, the second container at least partially surrounding the sound emitter, and
wherein the first container at least partially surrounds and is spaced apart from the second container, optionally wherein the liquid is retained between the first container walls and the second container walls, further optionally wherein the first container defines a volume of at least 0.5 m³.

6. (canceled)

7. Apparatus according to claim 1, wherein the liquid comprises water, optionally wherein the liquid comprises hydrogen peroxide, further optionally wherein the liquid comprises an enzyme for the decomposition of hydrogen peroxide, further optionally wherein the liquid comprises a surfactant.

8. (canceled)

9. (canceled)

10. (canceled)

11. Apparatus according to claim 1, wherein the liquid comprises at least 10% dissolved oxygen by volume.

12. Apparatus according to claim 1, wherein an agitation region surrounds the agitator, and wherein the agitator is configured to cause sufficient bubbles to form that the combined volume of bubbles is at least 1% of the total volume of the agitation region.

13. (canceled)

14. Apparatus according to claim 1, wherein the container comprises one or more barriers, the or each barrier extending across the interior of the container to thereby form a plurality of sub-containers, optionally wherein each of the plurality of sub-containers has a respective agitator provided therein.

15. Apparatus according to claim 1 comprising a pump configured to cause flow of liquid at the liquid surface, optionally in a downward direction.

16. Apparatus according to claim 1, wherein an agitation region surrounds the agitator, and wherein the agitator is configured to cause sufficient bubbles to form that, in the agitation region, the optical intensity of light having travelled through 10 centimetres of the liquid is reduced by at least 10% as compared to the intensity of that light before travelling through the liquid, optionally wherein the apparatus further comprises a light detector configured to output an indicator of the intensity of light having passed through a distance of the liquid.

17. (canceled)

18. Apparatus according to claim 16, comprising a controller configured to:
receive the indicator of the intensity of light having passed through the distance of the liquid; and
regulate the amount of agitation caused by the agitator, responsive to the received indicator to thereby maintain a target light intensity.

19. Apparatus according to claim 1, wherein the sound emitter comprises a marine piling apparatus.

20. An apparatus for limiting transmission of sound from a sound emitter, the apparatus comprising:
a sound barrier, the sound barrier comprising a container retaining a liquid, wherein the liquid comprises at least 2% dissolved oxygen by volume; and,
an agitator configured to agitate the liquid, to thereby cause the formation of gas bubbles in the liquid.

21. An apparatus according to claim 1, wherein the apparatus is configured to activate the agitator for an activation period, to thereby cause the generation of sufficient bubbles such that bubbles will then be suspended in the fluid for an attenuation period that is longer than the activation period.

22. A method of limiting transmission of sound from a sound emitter, the sound emitter being at least partially surrounded by a liquid, the liquid comprising at least 2% dissolved oxygen by volume, and the method comprising:
causing agitation of the liquid in the container to thereby cause the formation of gas bubbles in the liquid,
optionally wherein the liquid is retained by a container, the container at least partially surrounding the sound emitter.

23. A method according to claim 22, wherein the method comprises causing gas bubbles to form comprises causing oxygen to be released out of the liquid to thereby form bubbles.

24. A method according to claim 22, the method comprising:
receiving an indicator of the intensity of light having passed through a distance of the liquid; and
regulating the amount of agitation caused, responsive to the received indicator, to thereby maintain a target light intensity.

25. A method according to claim 22, the method further comprising:
causing mixing of water, hydrogen peroxide, and a catalyst for the decomposition of hydrogen peroxide to thereby form the liquid comprising water and at least 2% dissolved oxygen by volume.

26. An apparatus according to claim 1, wherein the apparatus further comprises an agitator disposed in the liquid, the agitator configured to agitate the liquid proximal to the agitator, to thereby cause the formation of gas bubbles in the liquid.

27. (canceled)
